(19) United States
(12) Patent Application Publication
(10) Pub. No.: US 2026/0206006 A1
(43) Pub. Date: Jul. 16, 2026

(54) METHOD FOR PERFORMING SIDELINK COMMUNICATION IN WIRELESS COMMUNICATION SYSTEM AND DEVICE THEREFOR

(71) Applicant: DONGGUK UNIVERSITY INDUSTRY-ACADEMIC COOPERATION FOUNDATION, Seoul (KR)

(72) Inventors: Seunghoon HWANG, Seoul (KR); Jicheng YIN, Seoul (KR)

(21) Appl. No.: 19/132,351

(22) PCT Filed: Nov. 21, 2023
(86) PCT No.: PCT/KR2023/018835

§ 371 Date: May 22, 2025

(30) Foreign Application Priority Data
Nov. 22, 2022 (KR) 10-2022-0157687

(51) Int. Cl. H04W 72/02; H04W 72/25; H04W 72/542

(52) U.S. Cl. CPC H04W 72/02; H04W 72/25; H04W 72/542

(57) ABSTRACT

A method for performing sidelink transmission by a terminal in a wireless communication system comprises the steps of: receiving sidelink control information (SCI) from at least one terminal; receiving a physical sidelink shared channel (PSSCH) from the at least one terminal; reselecting a specific resource for performing the sidelink transmission from among resources for resource reselection, the resources being determined on the basis of (i) information on a resource allocated to the at least one terminal, the information being included in the SCI, and (ii) RSRP measured on the basis of the PSSCH; and performing the sidelink transmission on the reselected specific resource.

### TECHNICAL FIELD

The present disclosure relates to wireless communication systems, and more particularly to methods and apparatus for performing sidelink communications.

### BACKGROUND ART

Since the commercialization of fourth generation (4G) communication systems, efforts have been made to develop improved fifth generation (5G) communication systems or pre-5G communication systems to meet the growing demand for wireless data traffic. For this reason, 5G communication systems or pre-5G communication systems are often referred to as Beyond 4G Network (Beyond 4G Network) communication systems or Post LTE (Long-Term Evolution) systems. To achieve high data rates, 5G communication systems are being considered for implementation in ultra-high frequency (mmWave) bands (e.g., the 60 Giga (70 GHz) band). To mitigate the path loss of radio waves in the ultra-high frequency band and increase the transmission distance of radio waves, beamforming, massive MIMO, full dimensional MIMO (FD-MIMO), array antenna, analog beam-forming, and large scale antenna techniques are being discussed for 5G communication systems. In addition, to improve the system's network, 5G communication systems are developing technologies such as advanced small cell, enhanced small cell, cloud radio access network (cloud RAN), ultra-dense network, device to device communication (D2D), wireless backhaul, moving network, cooperative communication, coordinated multi-points (CoMP), and interference cancellation. In addition, advanced coding modulation (ACM) schemes such as FQAM (Hybrid FSK and QAM Modulation) and SWSC (Sliding Window Superposition Coding) are being developed for 5G systems, as well as advanced access technologies such as FBMC (Filter Bank Multi Carrier), NOMA (non-orthogonal multiple access), and SCMA (sparse code multiple access).

Sidelink (SL) refers to a communication method that establishes a direct link between user equipment (UE)/terminal, bypassing the base station (BS) and directly exchanging voice or data between UEs. SL is being considered as a way to solve the burden on base stations due to rapidly increasing data traffic.

Vehicle-to-everything (V2X) refers to a communication technology that exchanges information with other vehicles, pedestrians, infrastructure, etc. through wired and wireless communication. V2X can be categorized into four types: vehicle-to-vehicle (V2V), vehicle-to-infrastructure (V2I), vehicle-to-network (V2N), and vehicle-to-pedestrian (V2P). V2X communication can be provided via PC5 interface and/or Uu interface.

Meanwhile, as more and more communication devices require greater communication capacity, there is a need for improved mobile broadband communication compared to conventional Radio Access Technology (RAT). Accordingly, communication systems that consider reliability and latency-sensitive services or terminals are being discussed, and next-generation radio access technologies that consider improved mobile broadband communication, massive machine type communication (MTC), ultra-reliable and low latency communication (URLLC), etc. can be referred to as new radio access technology (new RAT) or new radio (NR). NR may also support vehicle-to-everything (V2X) communications.

### DISCLOSURE

### Technical Problem

The present disclosure provides a method and apparatus for performing a sidelink transmission in a wireless communication system.

The disclosure also provides a method and apparatus for performing resource reselection during a sidelink transmission.

Further, the present disclosure provides a method and apparatus for updating a parameter setting for resource reselection upon performing resource reselection upon sidelink transmission.

The technical problems to be solved by the present disclosure are not limited to those mentioned above, and other technical problems not mentioned will become apparent to one having ordinary knowledge in the technical field to which the present disclosure belongs from the following description.

### Technical Solution

The present disclosure provides a method for a terminal to perform a sidelink transmission in a wireless communication system.

More specifically, in the present disclosure, A method for a terminal to perform a sidelink transmission in a wireless communication system, receiving, from at least one terminal, sidelink control information (SCI); receiving, from the at least one terminal, a physical sidelink shared channel (PSSCH); reselecting a specific resource for performing the sidelink transmission, from among resources for resource reselection determined based on (i) information on resources allocated to the at least one terminal, included in the SCI and (ii) reference signals received power (RSRP) measured based on the PSSCH; and performing the sidelink transmission on the specific reselected resource, wherein resource reselection parameters associated with the resource reselection are reset based on a specific ratio value, which is calculated by dividing (i) a sum of received signal strength indicator (RSSI) matrices obtained based on signals received respectively from terminals using same resource as the reselected specific resource by (ii) a value of one of matrices corresponding to a lower specific ratio of all RSSI matrices obtained based on signals received respectively from all terminals participating in the sidelink communication.

Furthermore, wherein the resource reselection parameter comprises at least one of (i) a resource reselection probability value, (ii) a packet delay budget (PDB) representing a maximum time that a delay in the side link transmission to be allowed, or (iii) a reselection counter value associated with a determination of whether to perform resource reselection.

Furthermore, wherein the specific ratio value is one of (i) a value within a predefined range that is equal to or greater than zero and less than one, and (ii) a value outside the predefined range,

Furthermore, wherein the specific ratio value is associated with the resource reselection probability value: a mapping relationship between the at least one sub-range and the resource reselection probability value having a non-zero value is predefined, the specific ratio value having a value outside the predefined range is mapped to the resource reselection probability value having a value of zero.

Furthermore, wherein the specific ratio value is associated with the PDB: a mapping relationship is predefined between (i) the at least one sub-range and values outside the predefined range and (ii) a timing value for a start time and a timing value for an end time of a time interval associated with the PDB on a time resource.

Furthermore, wherein a PDB time length determined based on the timing value for the start of the time interval associated with the PDB mapped to a value outside the predefined range and the timing value for the end is shorter than a PDB time length determined based on the timing value for the start of the time interval associated with the PDB mapped to the at least one sub-range and the timing value for the end.

Furthermore, wherein the specific ration value is associated with the reselection counter value: a mapping relaxation between the at least one sub-range and candidate value of the reselection counter value is pre-defined, the value outside the predefined range is mapped to the candidate value having 1 of the reselection counter value.

Furthermore, determining whether the reselected specific resource is a resource satisfying the reset PDB.

Furthermore, wherein in case that the reselected specific resource is the resource satisfying the PDB, further comprising: determining whether the reset reselection counter value is 0, in case that the reset reselection counter value is not 0, the reset reselection counter value is decremented by 1, and the sidelink transmission is performed, in case that the reset reselection counter value is 0, the reset reselection counter value is decremented by 1, and the sidelink transmission is performed, another resource reselection is performed, and the another resource reselection is performed based on the reset resource reselection probability value.

Furthermore, wherein in case that the reselected specific resource is a resource that does not satisfy the PDB, another resource reselection is performed, and the another resource reselection is performed based on the reset resource reselection probability value.

Furthermore, A terminal for performing a sidelink transmission in a wireless communication system, the terminal comprising: one or more transmitters and receivers; one or more processors; and one or more memories associated with the one or more processors, storing instructions for operations executed by the one or more processors, wherein the operations comprise, receiving, from at least one terminal, sidelink control information (SCI); receiving, from the at least one terminal, a physical sidelink shared channel (PSSCH); reselecting a specific resource for performing the sidelink transmission, from among resources for resource reselection determined based on (i) information on resources allocated to the at least one terminal, included in the SCI and (ii) reference signals received power (RSRP) measured based on the PSSCH; and performing the sidelink transmission on the specific reselected resource, wherein resource reselection parameters associated with the resource reselection are reset based on a specific ratio value, which is calculated by dividing (i) a sum of received signal strength indicator (RSSI) matrices obtained based on signals received respectively from terminals using same resource as the reselected specific resource by (ii) a value of one of matrices corresponding to a lower specific ratio of all RSSI matrices obtained based on signals received respectively from all terminals participating in the sidelink communication.

Furthermore, an apparatus comprising one or more memories and one or more processors functionally coupled to the one or more memories, wherein the one or more processors controls the apparatus to: receive, from at least one terminal, sidelink control information (SCI); receive, from the at least one terminal, a physical sidelink shared channel (PSSCH); reselect a specific resource for performing the sidelink transmission, from among resources for resource reselection determined based on (i) information on resources allocated to the at least one terminal, included in the SCI and (ii) reference signals received power (RSRP) measured based on the PSSCH; and perform the sidelink transmission on the specific reselected resource, wherein resource reselection parameters associated with the resource reselection are reset based on a specific ratio value, which is calculated by dividing (i) a sum of received signal strength indicator (RSSI) matrices obtained based on signals received respectively from terminals using same resource as the reselected specific resource by (ii) a value of one of matrices corresponding to a lower specific ratio of all RSSI matrices obtained based on signals received respectively from all terminals participating in the sidelink communication.

Furthermore, a non-transitory computer-readable medium storing one or more instructions, the one or more instructions executable by one or more processors controls the terminal to: receive, from at least one terminal, sidelink control information (SCI); receive, from the at least one terminal, a physical sidelink shared channel (PSSCH); reselect a specific resource for performing the sidelink transmission, from among resources for resource reselection determined based on (i) information on resources allocated to the at least one terminal, included in the SCI and (ii) reference signals received power (RSRP) measured based on the PSSCH; and perform the sidelink transmission on the specific reselected resource, wherein resource reselection parameters associated with the resource reselection are reset based on a specific ratio value, which is calculated by dividing (i) a sum of received signal strength indicator (RSSI) matrices obtained based on signals received respectively from terminals using same resource as the reselected specific resource by (ii) a value of one of matrices corresponding to a lower specific ratio of all RSSI matrices obtained based on signals received respectively from all terminals participating in the sidelink communication.

### Advantageous Effects

The present disclosure has the effect of enabling sidelink transmission in a wireless communication system.

The disclosure further provides for performing resource reselection during a sidelink transmission.

The disclosure also has the effect of updating a parameter setting for resource reselection when performing resource reselection during a sidelink transmission, such that appropriate parameter settings reflecting sidelink channel conditions can be set.

Further, the disclosure has the effect of increasing sidelink communication efficiency by setting appropriate parameters reflecting the sidelink channel situation.

The effects that can be obtained from the present disclosure are not limited to the effects mentioned above, and other effects that have not been mentioned will be clearly understood by one having ordinary knowledge in the technical field to which the present disclosure belongs from the following description.

### DESCRIPTION OF DRAWINGS

The accompanying drawings, which are incorporated as part of the detailed description to facilitate an understanding of the present disclosure, provide embodiments of the present disclosure and, together with the detailed description, describe technical features of the present disclosure.

FIG. 1 illustrates an example of a wireless network in accordance with embodiments of the present disclosure.

FIG. 2 illustrates an example of a base station, in accordance with embodiments of the present disclosure.

FIG. 3 illustrates an example of a terminal according to embodiments of the present disclosure.

FIG. 4 is a diagram illustrating a basic structure of a time-frequency domain, a radio resource domain in which data or control channels are transmitted in an NR system according to one embodiment of the present disclosure.

FIGS. 5 and 6 schematically illustrate the structure of a radio frame as applied to the present disclosure.

FIG. 7 is a diagram illustrating an example of performing sidelink communication.

FIG. 8 is a diagram to illustrate the concept of cellular network-based D2D communication as applied to the present disclosure.

FIG. 9 is a drawing illustrating a system according to one embodiment of the present disclosure.

FIG. 10 is a drawing to illustrate a resource pool, defined as a set of time and frequency resources used for transmitting and receiving sidelinks in accordance with one embodiment of the present disclosure.

FIG. 11 is a flow diagram to illustrate a method of scheduled resource allocation (mode 1) in a sidelink according to one embodiment of the present disclosure.

FIG. 12 is a flow diagram to illustrate a method of UE autonomous resource allocation (mode 2) in a sidelink, according to one embodiment of the present disclosure.

FIG. 13 is a diagram illustrating an example of resource reselection behavior of a terminal in a sidelink communication.

FIG. 14 is a flow diagram illustrating one example of a resource reselection behavior of a terminal in a sidelink communication.

FIG. 15 is a flow diagram illustrating one example of a resource reselection operation of a terminal in sidelink communication.

FIG. 16 is a flow diagram illustrating another example of resource reselection behavior of a terminal in sidelink communication.

FIGS. 17 and 18 are diagrams illustrating an example scenario in which the resource reselection method proposed in the present disclosure is performed.

FIG. 19 is a flow diagram illustrating one example of a scenario in which the resource reselection method proposed herein is performed.

FIGS. 20 and 21 are diagrams illustrating one example scenario in which the resource reselection method proposed herein is performed.

FIG. 22 is a flow diagram illustrating one example of a scenario in which a resource reselection method of the present disclosure is performed.

FIG. 23 is a diagram illustrating an example scenario in which the resource reselection method proposed herein is performed.

FIG. 24 is a flow diagram illustrating one example of a scenario in which the resource reselection method proposed herein is performed.

FIGS. 25a through 25d and FIG. 26 are diagrams illustrating the improved effectiveness of resource reselection behavior using the method proposed herein compared to resource reselection behavior based on a fixed use of resource reselection-related parameters.

FIG. 27 is a flow diagram illustrating an example of how the method for performing a sidelink transmission proposed in the present disclosure is performed in a terminal.

### MODE FOR INVENTION

In various embodiments of the present disclosure, “/” and “,” should be interpreted to indicate “and/or”. For example, “A/B” may mean “A and/or B”. Further, “A, B” may mean “A and/or B”. Further, “A/B/C” may mean “at least one of A, B, and/or C”. Further, “A, B, C” may mean “at least one of A, B, and/or C”.

In various embodiments of the present disclosure, “or” should be interpreted to mean “and/or”. For example, “A or B” may include “only A”, “only B”, and/or “both A and B”. In other words, “or” should be interpreted to mean “additionally or alternatively”.

The following technologies can be used in various wireless communication systems, such as code division multiple access (CDMA), frequency division multiple access (FDMA), time division multiple access (TDMA), orthogonal frequency division multiple access (OFDMA), single carrier frequency division multiple access (SC-FDMA), and the like. CDMA can be implemented in radio technologies such as universal terrestrial radio access (UTRA) or CDMA2000. TDMA can be implemented in wireless technologies such as GSM (global system for mobile communications)/GPRS (general packet radio service)/EDGE (enhanced data rates for GSM evolution). OFDMA can be implemented in wireless technologies such as IEEE (institute of electrical and electronics engineers) 802.11 (Wi-Fi), IEEE 802.16 (WiMAX), IEEE 802-20, E-UTRA (evolved UTRA), etc. IEEE 802.16m is an evolution of IEEE 802.16e and provides backward compatibility with systems based on IEEE 802.16e. UTRA is part of the universal mobile telecommunications system (UMTS). The 3rd generation partnership project (3GPP) LTE (long term evolution) is part of E-UMTS (evolved UMTS) using E-UTRA (evolved-UMTS terrestrial radio access), which employs OFDMA in the downlink and SC-FDMA in the uplink. LTE-A (advanced) is an evolution of 3GPP LTE.

5G NR is the successor to LTE-A and is a new clean-slate mobile communication system with characteristics such as high performance, low latency, and high availability. 5G NR can utilize all available spectrum resources, from the low frequency bands below 1 GHz to the mid-frequency bands from 1 GHz to 10 GHz and the high frequency (millimeter wave) bands above 24 GHz.

For clarity of description, LTE-A or 5G NR will be described, but the technical ideas of one embodiment of the present disclosure are not limited thereto.

In order to meet the growing demand for wireless data traffic since the commercialization of 4G communication systems, efforts are being made to develop improved 5G communication systems or pre-5G communication systems. For this reason, 5G communication systems or pre-5G communication systems are often referred to as Beyond 4G Network (Beyond 4G Network) communication systems or Post LTE (Post LTE) systems. The 5G communication system defined by 3GPP is called the New Radio (NR) system. To achieve high data rates, 5G communication systems are being considered for implementation in ultra-high frequency (mmWave) bands (e.g., 60 GHz). In order to mitigate the path loss of radio waves in the ultra-high frequency band and increase the transmission distance of radio waves, beamforming, massive MIMO, full dimensional MIMO (FD-MIMO), array antenna, analog beam-forming, and large scale antenna techniques have been discussed and applied to NR systems in 5G communication systems. In addition, to improve the network of the system, 5G communication systems are developing technologies such as advanced small cell, improved small cell, cloud radio access network (cloud RAN), ultra-dense network, device to device communication (D2D), wireless backhaul, moving network, cooperative communication, coordinated multi-points (CoMP), and interference cancellation. In addition, advanced coding modulation (ACM) schemes such as FQAM (Hybrid FSK and QAM Modulation) and SWSC (Sliding Window Superposition Coding) are being developed for 5G systems, as well as advanced access technologies such as FBMC (Filter Bank Multi Carrier), NOMA (non-orthogonal multiple access), and SCMA (sparse code multiple access).

Meanwhile, the Internet is evolving from a human-centered network of connections where humans create and consume information to an Internet of Things (IoT) network where information is exchanged and processed among distributed components such as objects. Internet of Everything (IoE) technology, which combines IoT technology with big data processing technology through connections to cloud servers, is also emerging. To realize IoT, technology elements such as sensing technology, wired and wireless communication and network infrastructure, service interface technology, and security technology are required, and recently, technologies such as sensor network, machine to machine (M2M), and machine type communication (MTC) have been researched for connecting objects. In the IoT environment, intelligent IT (Internet Technology) services that create new value for human life by collecting and analyzing data generated by connected objects can be provided. IoT can be applied to fields such as smart homes, smart buildings, smart cities, smart or connected cars, smart grids, healthcare, smart appliances, and advanced medical services through convergence and complexity between existing information technology (IT) and various industries.

Therefore, various attempts are being made to apply 5G communication systems to IoT networks. For example, technologies such as sensor network, machine to machine (M2M), and machine type communication (MTC) are being implemented using 5G communication technologies such as beamforming, MIMO, and array antennas. The application of cloud radio access network (cloud RAN) as a big data processing technology described above is also an example of the convergence of 5G and IoT technologies.

On the other hand, NR (New Radio access technology), a new 5G communication, is designed to allow various services to be freely multiplexed in time and frequency resources, so that waveforms/numerology, reference signals, etc. can be dynamically or freely allocated according to the needs of the service. In wireless communication, optimized data transmission through measurement of channel quality and interference is important to provide optimal services to terminals, and accurate channel state measurement is essential. However, unlike 4G communication, where the channel and interference characteristics do not change significantly depending on the frequency resource, 5G channels require the support of a subset of frequency resource groups (FRGs) that can be divided and measured, as the channel and interference characteristics change significantly depending on the service. On the other hand, the types of services supported in NR systems can be divided into categories such as enhanced mobile broadband (eMBB), massive Machine Type Communications (mMTC), and Ultra-Reliable and low-latency Communications (URLLC). eMBB is a high-speed transmission of high-capacity data, mMTC is a service aimed at minimizing terminal power and connecting multiple terminals, and URLLC is a service aimed at high reliability and low latency. Depending on the type of service applied to a terminal, different requirements may be applied.

As such, a plurality of services may be provided to a user in a communication system, and in order to provide such a plurality of services to a user, a method and apparatus that can provide each service within the same time window according to its characteristics are required.

Hereinafter, embodiments of the present disclosure will be described in detail with reference to the accompanying drawings.

In describing the embodiments, technical details that are well known in the technical field to which the present disclosure belongs and that are not directly related to the present disclosure will be omitted. This is done to make the disclosure clearer without obscuring the main points of the disclosure by omitting unnecessary explanations.

For the same reason, in the accompanying drawings, some components are exaggerated, omitted, or shown schematically. Also, the dimensions of each component are not intended to be entirely reflective of its actual size. In each drawing, identical or corresponding components are given the same reference numerals.

The advantages and features of the present disclosure, and methods of achieving them, will become apparent upon reference to the embodiments described in detail with reference to the accompanying drawings. However, the disclosure is not limited to the embodiments disclosed herein, but may be embodied in many different forms, and these embodiments are provided merely to make the disclosure complete and to give those of ordinary skill in the art to which the disclosure belongs a complete idea of the scope of the disclosure, which is defined by the claims. Throughout the disclosure, the same reference numerals refer to the same components.

At this point, it will be understood that each block of the processing flowchart illustrations and combinations of the flowchart illustrations may be performed by computer program instructions. These computer program instructions may be loaded into a processor of a general purpose computer, a special purpose computer, or other programmable data processing equipment, such that the instructions, when executed by the processor of the computer or other programmable data processing equipment, create means for performing the functions described in the flowchart block(s). The computer program instructions may be stored in computer-available or computer-readable memory that may direct the computer or other programmable data processing equipment to perform the functions in a particular manner, so that the instructions stored in the computer-available or computer-readable memory may produce an article of manufacture comprising the instructional means for performing the functions described in the flowchart block(s). The computer program instructions can also be loaded onto a computer or other programmable data processing equipment, such that a sequence of operational steps is performed on the computer or other programmable data processing equipment to create a computer-executable process, such that the instructions for performing the computer or other programmable data processing equipment provide steps for performing the functions described in the flowchart block(s).

Further, each block may represent a module, segment, or portion of code that includes one or more executable instructions for performing a particular logical function(s). It should also be noted that in some alternative execution examples, the functions mentioned in the blocks may occur out of sequence. For example, two blocks shown one after the other may in fact be performed substantially simultaneously, or the blocks may be performed in reverse order, depending on the functions they sometimes perform.

As used herein, the term “part” refers to software or a hardware component, such as an FPGA or ASIC, that performs some function. However, “part” is not limited to software or hardware. The “~part” may be configured to be on an addressable storage medium or may be configured to reproduce one or more processors. Thus, in one example, “part” includes components, such as software components, object-oriented software components, class components, and task components, processes, functions, attributes, procedures, subroutines, segments of program code, drivers, firmware, microcode, circuits, data, databases, data structures, tables, arrays, and variables. The functionality provided within components and parts may be combined into fewer components and parts or further separated into additional components and parts. Furthermore, the components and parts may be implemented to play one or more CPUs within the device or secure multimedia card. Furthermore, in embodiments, the “to part” may include one or more processors.

Wireless communication systems have evolved from providing initially voice-oriented services to broadband wireless communication systems that provide high-speed, high-quality packet data services, for example, using communication standards such as 3GPP's high speed packet access (HSPA), LTE (long term evolution or evolved universal terrestrial radio access (E-UTRA), LTE-Advanced (LTE-A), 3GPP2's high rate packet data (HRPD), ultra mobile broadband (UMB), and IEEE's 802.16e. In addition, 5G or NR (new radio) communication standards are being created as the fifth generation wireless communication system.

As a typical example of a broadband wireless communication system, the NR system employs orthogonal frequency division multiplexing (OFDM) in the downlink (DL) and uplink (UL). More specifically, CP-OFDM (cyclic-prefix OFDM) is adopted for the downlink, and CP-OFDM and DFT-S-OFDM (discrete Fourier transform spreading OFDM) are adopted for the uplink. The uplink refers to a wireless link that transmits data or control signals from the terminal (user equipment (UE) or mobile station (MS)) to the base station (gNode B, or base station (BS)), and the downlink refers to a wireless link that transmits data or control signals from the base station to the terminal. In the above multiple access method, the data or control information of each user is usually distinguished by allocating and operating the time and frequency resources to carry data or control information for each user so that orthogonality is established.

### Wireless Networks General

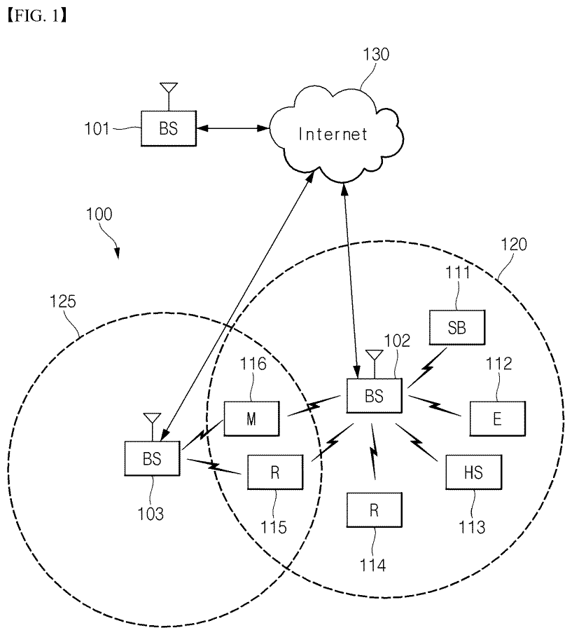

FIGS. 1-3 illustrate various embodiments implemented in the wireless communication systems disclosed below and using orthogonal frequency division multiplexing (OFDM) or orthogonal frequency division multiple access.

FIGS. 1 to 3 are not intended to be physical or structural limitations on how other embodiments may be implemented. Other embodiments of the disclosure may be implemented in any suitably arranged communication system.

FIG. 1 illustrates an example of a wireless network in accordance with embodiments of the present disclosure. The example embodiment of the wireless network shown in FIG. 1 is for illustrative purposes only. Other embodiments of the wireless network 100 may be used without departing from the scope of the present disclosure.

As shown in FIG. 1, the wireless network may include a gNB 101, a gNB 102, and a gNB 103. Further, gNB 101 may be in communication with at least one network 103, such as the internet, a proprietary internet protocol (IP) network, or another data network.

The gNB 102 may provide wireless broadband access to the network 130 for a first plurality of user equipment (UE) within the coverage area 120 of the gNB 102. The first plurality of user equipment may include a user device 111 that may be located at a small business (SB), a user device 112 that may be located at an enterprise (E), a user device 113 that may be located at a WIFI hotspot (HS), a UE that may be located at a first residence (residence, R), ULE 114, which may be located in a second residence, UE 115, which may be located in a third residence, and UE 115, which may be located in a mobile device, such as, for example, a cell phone, a wireless laptop, a wireless PDF, or the like.

The gNB 103 may provide wireless broadband access to the network 130 for a second plurality of UEs within the coverage area 125 of the gNB 103. The second plurality of UEs may include UE 115, UE 116, and so forth. According to one embodiment, the at least one or more gNBs 101-103 may communicate with each other and with the UEs 111-116 using 5G, LTE, LTE-A, WiMAX, WIFI, or other wireless communication technologies.

Depending on the type of network, the term “base station” or “base station” or “BS” may refer to any component (or collection of components) configured to provide wireless access to a network, such as a transmit point (TP), a transmit-receive point (TRP), an enhanced base station (eNodeB or eNB), a 5G base station (gNB), a macrocell, a femtocell, a WiFi access point (AP), or other wireless-enabled device.

A base station may provide wireless access according to one or more wireless communication protocols, e.g., 5G 3GPP new radio interface/access (NR), long-term evolution (LTE), LTE advanced (LTE-A), high-speed packet access (HSPA)), Wi-Fi 802.11a/b/g/n/ac, etc. For convenience, the terms “BS” and “TRP” are used interchangeably in this patent document to refer to network infrastructure components that provide wireless access to remote terminals. In addition, depending on the type of network, the term “user equipment” or “UE” may refer to any component, such as a “mobile station”, “subscriber”, “remote terminal”, “wireless terminal”, “receiving point”, or “user device”.

For convenience, the terms “user equipment” and “UE” are used in this patent document to refer to remote wireless equipment that wirelessly accesses the BS, wherein the LUE is a mobile device (e.g., a mobile phone or smartphone) or is generally considered to be a fixed device (e.g., a desktop computer or vending machine).

The dashed lines indicate the approximate extent of coverage areas 120, and 125, which are shown as roughly circular for illustration and explanation only. Coverage areas 120 and 125 associated with a gNB may have different shapes, including irregular shapes, depending on the configuration of the gNB and variations in the wireless environment associated with natural and man-made obstacles.

As described in more detail below, the at least one or more UEs 111-116 may include circuitry, programming, or combinations thereof for reliable reception of data and control information in advanced wireless communication systems. In certain embodiments, the at least one or more gNBs 101-103 may include circuitry, programming, or combinations thereof for efficient network control resource allocation in new radio (NR) vehicle-to-everything (V2X).

FIG. 1 illustrates one example of a wireless network, but various modifications may be made to FIG. 1. For example, the wireless network may include any number of gNBs and any number of UEs in any suitable arrangement. Further, the gNBs 101 may communicate directly with any number of UEs and provide those UEs with wireless broadband access to the network 130. Similarly, each of gNBs 102-103 may communicate directly with network 130 and may provide UEs with direct wireless broadband access to network 130. Further, gNBs 101, 102, and/or 103 may provide access to other or additional external networks, such as external telephone networks or other types of data networks.

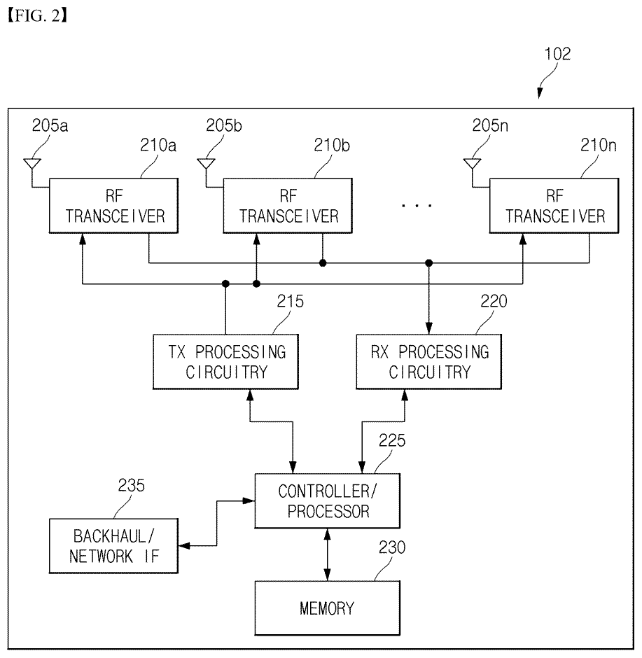

FIG. 2 illustrates an example of a gNB 102, in accordance with embodiments of the present disclosure. The embodiment of gNB 102 illustrated in FIG. 1 is for illustrative purposes only, and gNB 101 and gNB 103 of FIG. 1 may have the same or similar configurations. However, gNBs can be provided in a variety of configurations, and FIG. 2 does not limit the scope of the disclosure to any particular implementation of a gNB.

As shown in FIG. 2, the gNB 102 may include multiple antennas 205a-205n, multiple radio frequency (RF) transceivers 210a-210n, transmit (TX) processing circuitry 215, and receive (RX) processing circuitry 220. The gNB 102 may also include a controller/processor 225, memory 230, and a backhaul or network interface (network IF) 235.

RF transceivers 210a-210n may receive incoming RF signals, such as signals transmitted by UEs in network 100, from antennas 205a-205n. The RF transceivers 210a-210n may down-convert the incoming RF signals to generate intermediate frequency (IF) or baseband signals. The IF or baseband signals may be transmitted to RX processing circuit 220, which may generate processed baseband signals by filtering, decoding, and/or digitizing. RX processing circuit 220 may transmit the processed baseband signals to controller/processor 225 for further processing.

TX processing circuit 215 may receive analog or digital data (e.g., voice data, web data, email, interactive video game data) from controller/processor 225. TX processing circuitry 215 may encode, multiplex, and/or digitize the outgoing baseband data to generate processed baseband or IF signals.

Controller/processor 225 may include at least one processor or other processing unit that controls the overall operation of the gNB 102. For example, controller/processor 225 may control the reception of forward channel signals and transmission of reverse channel signals by RF transceivers 210a-210n, RX processing circuit 220, and TX processing circuit 215 according to well-known principles. Controller/processor 225 may also support additional functionality, such as more advanced wireless communication capabilities. For example, controller/processor 225 may support beam forming or directional routing operations where signals from multiple antennas 205a-205n are weighted differently to effectively steer them in a desired direction. Any of a variety of other functions may be supported by the controller/processor 225 in the gNB 102.

The controller/processor 225 can also execute programs and other processes residing in memory 230, such as an operating system (OS). The controller/processor 225 can move data in and out of memory 230 as required by the executing process.

In addition, controller/processor 225 may be connected to a backhaul or network interface 235. The backhaul or network interface 235 enables the gNB 102 to communicate with other devices or systems over a backhaul connection or network. Interface 235 may support communication over any suitable wired or wireless connection(s). For example, when the gNB 102 is implemented as part of a cellular communication system (e.g., supporting 5G, LTE, or LTE-A), the interface 235 may allow the gNB 102 to communicate with other gNBs over a wired or wireless backhaul connection. When the gNB 102 is implemented as an access point, the interface 235 may allow the gNB 102 to communicate with a wired or wireless local area network, or to a larger network (e.g., the Internet) over a wired or wireless connection. The interface 235 can include any suitable structure that supports communication over a wired or wireless connection, such as an Ethernet or RF transceiver.

Memory 230 may be coupled to controller/processor 225. A portion of memory 230 may include RAM, and other portions of memory 230 may include flash memory or other ROM.

While FIG. 2 illustrates one example of a gNB 102, various modifications can be made to FIG. 2. For example, the gNB 102 may include any number of each of the components shown in FIG. 2. As a specific example, the access point may include multiple interfaces 235, and the controller/processor 225 may support routing functionality for routing data between different network addresses. As another specific example, although shown as including a single instance of TX processing circuitry 215 and a single instance of RX processing circuitry 220, gNB 102 may include multiple instances of each (e.g., one per RF transmitter and receiver).

Further, the various components of FIG. 2 may be combined, further subdivided, or omitted, and additional components may be added based on specific needs.

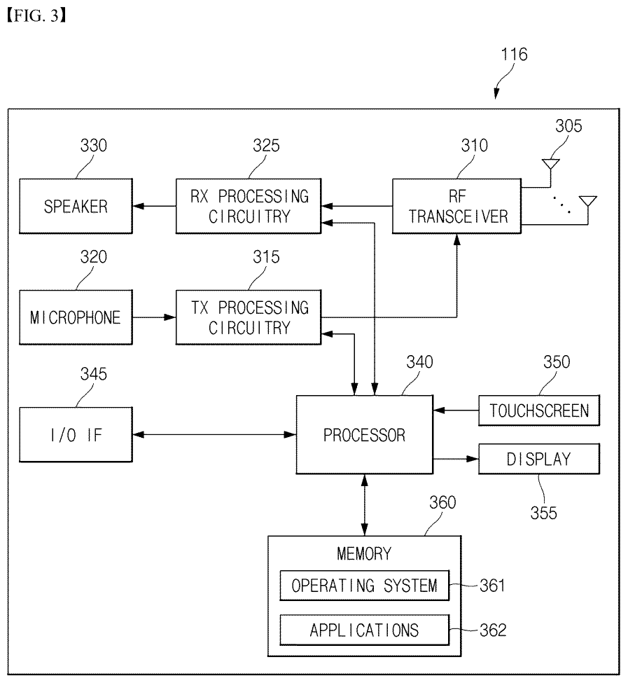

FIG. 3 illustrates an exemplary UE 116, in accordance with embodiments of the present disclosure. The embodiment of UE 116 shown in FIG. 3 is for illustrative purposes only, and may have the same or similar configuration as UEs 111-115 of FIG. 1. However, UEs are provided in a variety of configurations, and FIG. 3 does not limit the scope of this disclosure to any particular implementation of a UE.

As shown in FIG. 3, UE 116 may include antenna 305, radio frequency (RF) transceiver 310, transmit (TX) processing circuitry 315, microphone 320, and receive (RX) processing circuitry 325. The UE 116 may also include a speaker 330, a processor 340, an input/output (I/O) interface (IF) 345, a touch screen 350, a display 355, and a memory 360. Memory 360 may include an operating system (OS) 361 and one or more applications 362.

RF transceiver 310 can receive incoming RF signals transmitted by a gNB of network 100 from antenna 305. RF transceiver 310 can down-convert the incoming RF signal to generate intermediate frequency (IF) or baseband signals. The IF or baseband signals may be transmitted to RX processing circuit 325, which may generate baseband signals that are processed by filtering, decoding, and/or digitizing. RX processing circuit 325 may transmit the processed baseband signal to speaker 330 (e.g., speech data) or processor 340 for further processing (e.g., web browsing data).

TX processing circuit 315 can receive analog or digital voice data from microphone 320 or other outgoing baseband data (such as web data, email, or interactive video game data) from processor 340. TX processing circuitry 315 can encode, multiplex, and/or digitize the outgoing baseband data to generate a processed baseband or IF signal.

RF transceiver 310 may receive the transmit processed baseband or IF signal from TX processing circuit 315 and may up-convert the baseband or IF signal to an RF signal transmitted via antenna 305.

Processor 340 may include one or more processors or other processing devices and may execute OS 361 stored in memory 360 to control the overall behavior of UE 116. For example, controller/processor 225 may control the reception of forward channel signals and transmission of reverse channel signals by RF transceivers 210a-210n, RX processing circuit 220, and TX processing circuit 215 according to well-known principles. According to some embodiments, processor 340 may include one or more microprocessors or microcontrollers.

Additionally, processor 340 may execute other processes and programs residing in memory 360, such as processes for beam management. The processor 340 can move data into and out of memory 360 as required by the executing process. In one embodiment, processor 340 may be configured to execute application 362 based on OS 361 or in response to signals received from the gNB or an operator.

Further, the processor 340 may be connected to an I/O interface 345, which may provide the UE 116 with the ability to connect to other devices, such as laptop computers and handheld computers.

Additionally, processor 340 may be coupled to touch screen 350 and display 355. An operator of the UE 116 may use the touch screen 350 to enter data into the UE 116. Display 355 may be a liquid crystal display, light emitting diode display, or other display capable of rendering text and/or at least limited graphics, such as a website.

Memory 360 may be coupled to processor 340. A portion of memory 360 may include random access memory (RAM), and another portion of memory 360 may include flash memory or other read-only memory (ROM).

FIG. 3 illustrates one example of UE 116, which may be subject to various modifications. For example, various components of FIG. 3 may be combined, further subdivided, or omitted, and additional components may be added based on specific needs. As a specific example, processor 340 may be divided into multiple processors, such as one or more central processing units (CPUs) and one or more graphics processing units (GPUs). Further, FIG. 3 illustrates a UE 116 configured as a mobile phone or smartphone, although the UE may be configured to operate as any other type of mobile or fixed device.

The present disclosure relates generally to wireless communication systems, and more specifically to vehicular communication network protocols, including vehicle-to-device, vehicle-to-vehicle, and vehicle-to-network communication resource allocation and synchronization schemes.

The communication system may include a downlink (DL) that carries signals from a transmitting point, such as a base station (BS) or NodeB, to user equipment (UE), and an uplink (UL) that carries signals from UE to a receiving point, such as a NodeB.

Additionally, sidelinks (SLs) may carry signals from UEs to other UEs or other non-infrastructure-based nodes. UEs, also commonly referred to as terminals or mobile stations, can be fixed or mobile and can be cell phones, personal computer devices, and the like. NodeBs, which are typically fixed stations, may also be referred to by other equivalent terms such as access points or eNodeBs. The access network that includes the NodeBs associated with 3GPP LTE is referred to as the Evolved Universal Terrestrial Access Network (E-UTRAN).

### NR System Related

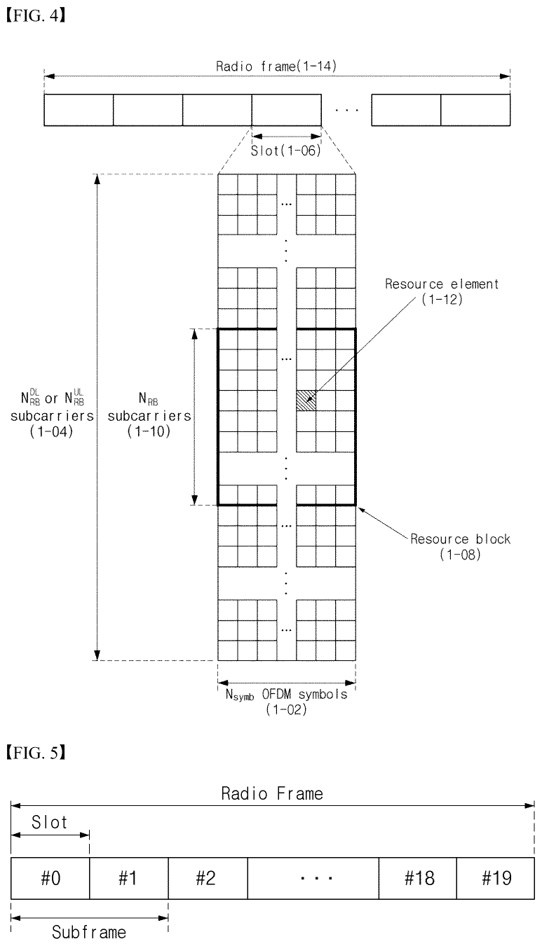

FIG. 4 is a diagram illustrating a basic structure of a time-frequency domain, which is a radio resource domain over which data or control channels are transmitted in an NR system according to one embodiment of the present disclosure.

Specifically, FIG. 4 illustrates a basic structure of a time-frequency domain, which is a radio resource domain over which data or control channels are transmitted in a downlink or uplink in an NR system.

Referring to FIG. 4, the horizontal axis represents the time domain and the vertical axis represents the frequency domain. The minimum transmission unit in the time domain is an OFDM symbol, and Nsymb of OFDM symbols 1-02 can be gathered to form one slot 1-06. The length of a subframe is defined as 1.0 ms, and a radio frame 1-14 is defined as 10 ms. The smallest unit of transmission in the frequency domain is a subcarrier, and the bandwidth of the entire system transmission bandwidth may comprise a total of NBW subcarriers 1-04.

The basic unit of a resource in the time-frequency domain is a resource element (1-12, resource element; RE), which may be represented by an OFDM symbol index and a subcarrier index. A resource block (1-08, resource block; RB or physical resource block; PRB) may also be defined as Nsymb contiguous OFDM symbols (1-02) in the time domain and NRB contiguous subcarriers (1-10) in the frequency domain. Thus, one RB 1-08 may comprise Nsymb×NRB of REs 1-12. In general, the smallest unit of data transmission is the RB unit. In NR systems, typically Nsymb=14, NRB=12, and NBW and NRB may be proportional to the bandwidth of the system transmission band. In addition, the data rate may be proportional to the number of RBs scheduled for the terminal.

In an NR system, the downlink and uplink transmission bandwidths may be different from each other in an FDD system where the downlink and uplink are frequency separated. The channel bandwidth can represent the RF bandwidth corresponding to the system transmission bandwidth. [Table 1 and Table 2 show some of the correspondences between system transmission bandwidth, subcarrier spacing, and channel bandwidth as defined for NR systems in frequency bands lower than 6 GHz and higher than 6 GHz, respectively. For example, an NR system with a 100 MHz channel bandwidth with a 30 kHz subcarrier width has a transmission bandwidth of 273 RBs. In the following, N/A can be any bandwidth-subcarrier combination that is not supported by the NR system.

TABLE 1

| Channel | | | | | | | |
|---|---|---|---|---|---|---|---|
| bandwidth | Subcarrier | 5 | 10 | 20 | 50 | 80 | 100 |
| BW_{Channel}[MHz] | spacing | MHz | MHz | MHz | MHz | MHz | MHz |
| Transmission | 15 kHz | 25 | 52 | 106 | 270 | N/A | N/A |
| bandwidth | 30 kHz | 11 | 24 | 51 | 133 | 217 | 273 |
| configuration | 60 kHz | N/A | 11 | 24 | 65 | 107 | 135 |
| N_{RB} | | | | | | | |

TABLE 2

| Channel | | | | | |
|---|---|---|---|---|---|
| bandwidth | Subcarrier | 50 | 100 | 200 | 400 |
| BW_{Channel}[MHz] | spacing | MHz | MHz | MHz | MHz |
| Transmission | 60 kHz | 66 | 132 | 264 | N/A |
| bandwidth | 120 kHz | 32 | 66 | 132 | 264 |
| configuration | | | | | |
| N_{RB} | | | | | |

In NR systems, the frequency range can be defined as FR1 and FR2, divided as shown in Table 3 below.

TABLE 3

| Frequency range | |
|---|---|
| designation | Corresponding frequency range |
| FR1 | 450 MHz-7125 MHz |
| FR2 | 24250 MHz-52600 MHz |

The ranges of FR1 and FR2 can also be changed and applied differently. For example, the frequency range of FR1 may be varied from 450 MHz to 6000 MHz.

In NR systems, scheduling information for downlink data or uplink data is communicated from the base station to the terminal via downlink control information (DCI). DCI can be defined according to different formats, each of which can indicate whether it is scheduling information for uplink data (UL grant) or downlink data (DL grant), whether it is a compact DCI where the size of the control information is below a certain size, whether spatial multiplexing using multiple antennas is applied, whether it is DCI for power control, etc. For example, the scheduling control information (DL grant) for downlink data, DCI format 1-1, may include at least one of the following control information

Carrier indicator: indicates on which frequency carrier the data is to be transmitted.

DCI format indicator: indicates whether the DCI is for downlink or uplink.

Bandwidth part (BWP) indicator: Indicates which BWP it is transmitted on.

Frequency domain resource allocation: Indicates the RB of the frequency range allocated for data transmission. The system bandwidth and resource allocation method determines the resources represented.

Time Domain Resource Allocation: Indicates which OFDM symbols in which slot will transmit the data-related channels.

VRB-to-PRB mapping: dictates how the virtual RB (VRB) index and physical RB (PRB) index are mapped.

Modulation and coding scheme (MCS): Specifies the modulation scheme used for data transmission and the size of the transport block, which is the data to be transmitted.

HARQ process number: Specify the HARQ process number.

new data indicator: Indicates whether the HARQ is initialized or retransmitted.

redundancy version: Indicates the redundancy version of the HARQ.

transmit power control (TPC) command for PUCCH (physical uplink control channel): Specifies the transmit power control command for the uplink control channel, PUCCH.

For data transmission via PDSCH or PUSCH, the time domain resource assignment can be determined by information about the slot in which the PDSCH/PUSCH is transmitted, the starting symbol position S in that slot, and the number of symbols L to which the PDSCH/PUSCH is mapped. S may be a position relative to the start of the slot, L may be a number of consecutive symbols, and S and L may be determined from a start and length indicator value (SLIV) defined as follows.

TABLE 4

```
if (L − 1) ≤ 7 then
  SLIV = 14·(L − 1) + S
else
  SLIV = 14·(14 − L + 1) + (14 − 1 − S)
where 0 < L ≤ 14 − S
```

In the NR system, the terminal may receive information about the SLIV value, the PDSCH/PUSCH mapping type, and the slot in which the PDSCH/PUSCH is transmitted in one row through the RRC setting (e.g., the information may be set in the form of a table). In the subsequent time domain resource allocation of the DCI, the base station may communicate the information about the SLIV value, the PDSCH/PUSCH mapping type, and the slot in which the PDSCH/PUSCH is transmitted to the terminal by indicating the index value in the set table.

In the NR system, PDSCH mapping type can be defined as type A and type B. The base station can send information to the terminal about the SLIV value, PDSCH/PUSCH mapping type, and the slot to which PDSCH/PUSCH is transmitted. According to PDSCH mapping type A, the first of the DMRS symbols may be located in the second or third OFDM symbol of the slot. According to PDSCH mapping type B, the first of the DMRS symbols may be located in the first OFDM symbol in the time domain resource allocated by the PUSCH transmission.

The DCI may be transmitted on the physical downlink control channel (PDCCH), which is the downlink physical control channel after channel coding and modulation. In this disclosure, when control information is transmitted over a PDCCH or PUCCH, it may be referred to as being transmitted over a PDCCH or PUCCH. Similarly, the disclosure may refer to data being transmitted over PUSCH or PDSCH as PUSCH or PDSCH being transmitted.

In general, the DCI may be scrambled into a specific radio network temporary identifier (RNTI) (or terminal identifier) independently for each terminal, appended with a cyclic redundancy check (CRC), channel coded, and transmitted as separate PDCCHs. The PDCCHs may be mapped and transmitted from a control resource set (CORESET) established by the terminal.

Downlink data may be transmitted on a physical downlink shared channel (PDSCH), which is a physical channel for downlink data transmission. The PDSCH may be transmitted after the control channel transmission section, and scheduling information such as the specific mapping position in the frequency domain and the modulation method may be determined based on the DCI transmitted over the PDCCH.

Among the control information comprising the DCI, the base station may notify the terminal via a modulation coding scheme (MCS) of the modulation scheme applied to the PDSCH to be transmitted and the size of the data to be transmitted (transport block size (TBS)). According to embodiments of the present disclosure, the MCS may consist of 5 bits or more or less bits. The transport block size (TBS) may correspond to the size of the data (transport block, TB) that the base station wishes to transmit before error correction channel coding is applied.

As used herein, a transport block (TB) may include a medium access control (MAC) header, a MAC control element (CE), one or more MAC service data units (SDUs), and padding bits. Alternatively, TB may represent a unit of data to be delivered from the MAC layer down to the physical layer, or a MAC protocol data unit (PDU).

The modulation schemes supported by NR systems are quadrature phase shift keying (QPSK), quadrature amplitude modulation (16QAM), 64QAM, and 256QAM, each with a modulation order (Qm) of 2, 4, 6, or 8. This means that 2 bits per symbol can be transmitted for QPSK modulation, 4 bits per symbol for 16QAM modulation, 6 bits per symbol for 64QAM modulation, and 8 bits per symbol for 256QAM modulation.

### LTE System Related

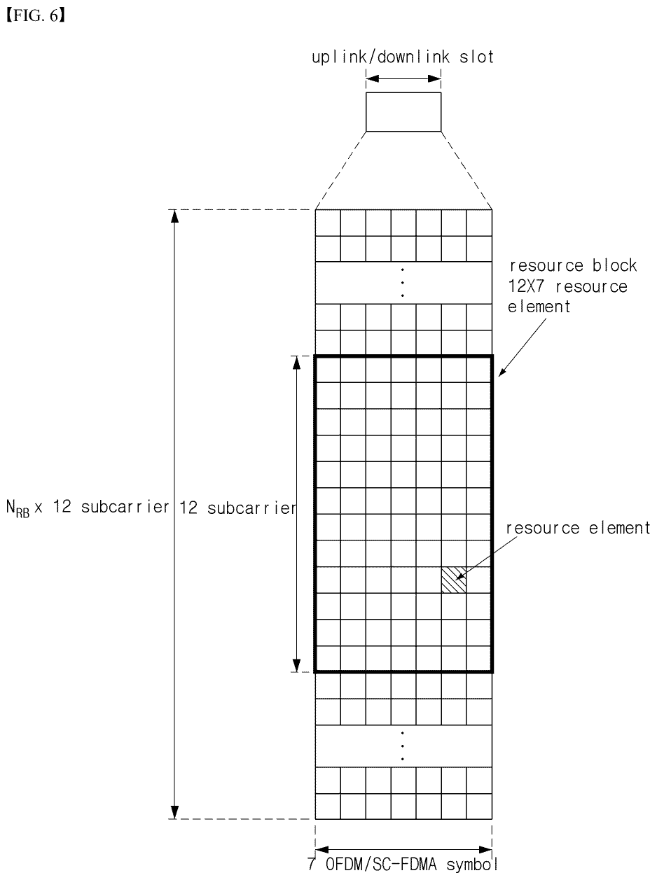

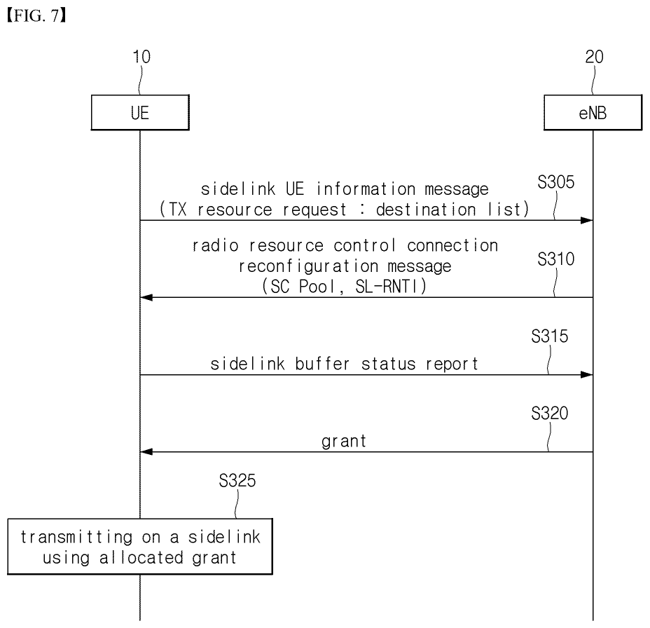

FIGS. 5 and 6 schematically illustrate the structure of a radio frame as applied to the present disclosure.

Referring to FIGS. 5 and 6, a radio frame includes 10 subframes, wherein a subframe includes two consecutive slots. The basic unit of time (length) for transmission control in a radio frame is called the Transmission Time Interval (TTI). A TTI may be 1 ms. A subframe may be 1 ms long and a slot may be 0.5 ms long.

A slot may include a plurality of symbols in the time domain. For example, for a wireless system using Orthogonal Frequency Division Multiple Access (OFDMA) in the downlink (DL), the symbols may be Orthogonal Frequency Division Multiplexing (OFDM) symbols, and for a wireless system using Single Carrier-Frequency Division Multiple Access (SC-FDMA) in the uplink (UL), the symbols may be Single Carrier-Frequency Division Multiple Access (SC-FDMA) symbols. On the other hand, the representation of a symbol period in the time domain is not limited by the multiple access method or designation.

The number of symbols in one slot may vary depending on the length of the Cyclic Prefix (CP). For example, for a normal CP, one slot can contain seven symbols, and for an extended CP, one slot can contain six symbols.

A resource element (RE) represents the smallest time-frequency unit to which modulation symbols on the data channel or modulation symbols on the control channel are mapped. A resource block (RB) is a unit of resource allocation and contains time-frequency resources corresponding to 180 kHz on the frequency axis and 1 slot on the time axis. On the other hand, a resource block pair (PBR) is a resource unit that contains two consecutive slots on the time axis.

At the physical layer, multiple physical channels may be utilized, and physical channels may be mapped to and transmitted in radio frames. As a downlink physical channel, the Physical Downlink Control Channel (PDCCH)/Enhanced PDCCH (EPDCCH) informs the terminal of the resource allocation of the Paging Channel (PCH) and Downlink Shared Channel (DL-SCH) and the Hybrid Automatic Repeat Request (HARQ) information related to the DL-SCH. The PDCCH/EPDCCH can issue uplink grants to inform the terminal of the resource allocation for uplink transmissions. PDCCH and EPDCCH differ in the resource areas they map to. PDSCH (Physical Downlink Shared Channel) is mapped to DL-SCH. The Physical Control Format Indicator Channel (PCFICH) informs the terminal of the number of OFDM symbols used in the PDCCH and is transmitted every subframe. The Physical Hybrid ARQ Indicator Channel (PHICH) is a downlink channel that carries HARQ (Hybrid Automatic Repeat reQuest) ACK (Acknowledgment)/NACK (Non-acknowledgment) signals in response to uplink transmissions. The HARQ ACK/NACK signal may be referred to as the HARQ-ACK signal.

As an uplink physical channel, the Physical Random Access Channel (PRACH) carries the random access preamble. The Physical Uplink Control Channel (PUCCH) carries HARQ-ACK in response to downlink transmissions, channel status information (CSI) indicating the state of the downlink channel, and uplink control information such as channel quality indicator (CQI), precoding matrix index (PMI), precoding type indicator (PTI), rank indicator (RI), etc. The Physical Uplink Shared Channel (PUSCH) carries the Uplink Shared Channel (UL-SCH).

Uplink data may be transmitted on the PUSCH, wherein the uplink data may be a Transport Block (TB), which is a block of data for the UL-SCH transmitted during a Transmission Time Interval (TTI). The transport block may include user data. Alternatively, the uplink data may be multiplexed data. The multiplexed data may be a transport block for UL-SCH and uplink control information multiplexed, i.e., if there is user data to be transmitted uplink, the uplink control information may be multiplexed with user data and transmitted via PUSCH.

### Sidelink(SL) General

The sidelink (SL) refers to the signal transmission and reception path between the terminal and the terminal, which can be used interchangeably with the PC5 interface. base station refers to the entity that performs the resource allocation of the terminal, which may be a base station that supports both V2X communication and regular cellular communication, or a base station that supports V2X communication only, i.e., a base station may be an NR base station (gNB), LTE base station (eNB), or road site unit (RSU) (or fixed station). A terminal can be a typical user equipment, a mobile station, but also a vehicle supporting vehicle-to-vehicle (V2V) communication, a vehicle supporting vehicle-to-pedestrian (V2P) communication, a vehicle or pedestrian's handset (e.g., a smartphone) supporting vehicle-to-network (V2N) communication, or a vehicle supporting vehicle-to-network (V2V) communication, V2N), a vehicle supporting vehicle-to-network (V2N) communication, or a vehicle supporting vehicle-to-infrastructure (V2I) communication, and an RSU equipped with terminal functionality, an RSU equipped with base station functionality, or an RSU equipped with some of the base station functionality and some of the terminal functionality. In the present disclosure, downlink (DL) refers to a wireless transmission path of a signal transmitted by a base station to a terminal, and uplink (UL) refers to a wireless transmission path of a signal transmitted by a terminal to a base station. Furthermore, although one embodiment of the present disclosure is described below based on an NR system, one embodiment of the present disclosure may be applied to a wireless communication system having a similar technical background or channel type. Furthermore, embodiments of the present disclosure may be applied to other communication systems with some modifications that do not substantially depart from the scope of the present disclosure as determined by those skilled in the art.

In this disclosure, the terms physical channel and signal may be used interchangeably with data or control signals. For example, a PDSCH is a physical channel over which data is transmitted, but a PDSCH can also refer to data being transmitted.

As used herein, higher-level signaling refers to a method of signaling from a base station to a terminal using a physical layer downlink data channel, or from a terminal to a base station using a physical layer uplink data channel, and may also be referred to as RRC signaling or MAC control element (CE).

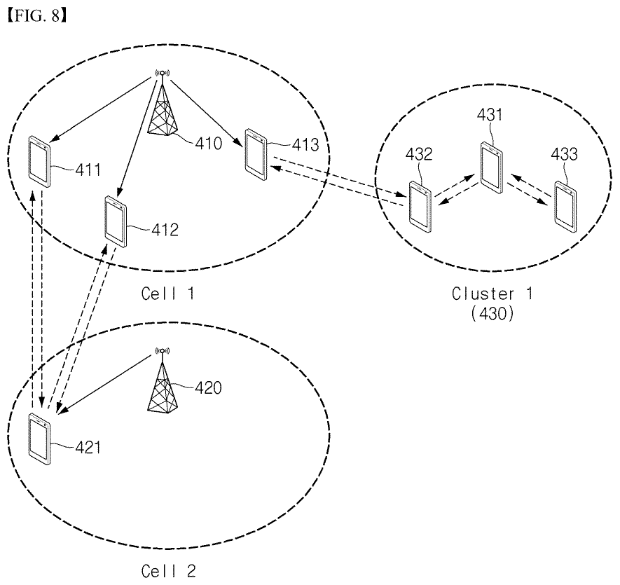

FIG. 7 is an illustration of performing sidelink communication.

Referring to FIG. 7, in order to transmit packets, the UE 10 at the transmit side requires resources (e.g., time and frequency) to transmit sidelink control data and sidelink data. To obtain the resources, the UE 10 interested in sidelink communication may send a sidelink UE information (SidelinkUEInformation) message containing a destination info list (destinationInfoList), i.e., a list of destinations, to the base station, i.e., the eNB 20 (S305).

The eNB 20 may allocate a sidelink resource pool (SC Pool) and sidelink radio network temporary identities (SL-RNTIs) for transmitting sidelink control data via a Radio Resource Control (RRC) connection reconfiguration message (S310). The sidelink resource pool represents time and frequency resources, i.e., at least one or more subframes and physical resource blocks (PRBs) of each subframe, over which sidelink control (scheduling control) data may be transmitted. Time and frequency may be periodically allocated by a sidelink control cycle.

The UE 10 may then transmit a sidelink buffer status report (BSR) to request a dedicated resource for transmitting the sidelink control data and sidelink data (S315).

The eNB 20 may allocate the dedicated resources and transmit information about the dedicated resources, i.e., the grant 201 for the sidelink communication (S320). The received single grant 201 may be for the first available sidelink control cycle starting a certain number of subframes after the subframe at the end of the grant allocation cycle N 220-N in which the single grant 201 was received. The ULE 10 may transmit in the first available sidelink control cycle 210 using only one single grant 201 (S325).

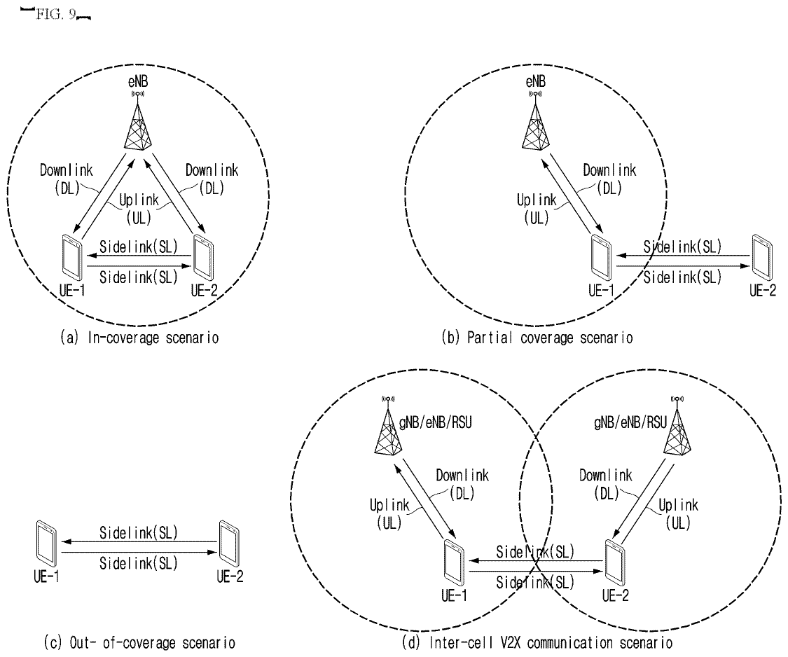

FIG. 8 is a drawing to illustrate concepts of cellular network-based D2D communications applicable to the present disclosure.

Referring to FIG. 8, a cellular communication network including a first base station 410, a second base station 420, and a first cluster 430 is configured. A first terminal 411 and a second terminal 412 belonging to a cell served by the first base station 410 communicate via a conventional access link (cellular link) through the first base station 410. This is an in-coverage-single-cell end-to-end communication scenario. On the other hand, the first terminal 411 belonging to the first base station 410 may perform end-to-end communication with the fourth terminal 421 belonging to the second base station 420. This is an in-coverage-multi-cell end-to-end communication scenario. Additionally, the fifth terminal 431 that is out of network coverage may form a cluster 430 with the sixth terminal 432 and seventh terminal 433 and perform end-to-end communication with them. This is an out-of-coverage end-to-end communication scenario. Additionally, the third terminal 413 may perform end-to-end communication with the sixth terminal 432, which is a partial-coverage end-to-end communication scenario. These end-to-end communication links can be between devices that have the same cell as a serving cell, between devices that have different cells as serving cells, between devices connected to a serving cell and devices that are not connected to a serving cell, or between devices that are not connected to a serving cell. In particular, D2D communication may be required between devices that are outside of network coverage for purposes such as public safety.

In order to perform D2D data transmission and reception via D2D communication, relevant control information must be transmitted and received between devices. The relevant control information may be referred to as a Scheduling Assignment (SA). The Rx terminal may perform a configuration for receiving D2D data based on the SA. The SA may include, for example, at least one of a New Data indicator (NDI), a Transmit UE Identification (Tx terminal ID), a Redundancy Version indicator (RV indicator), a Modulation and Coding Scheme Indication (MCS indication), a Resource Allocation (RA) indication, and a power control indication.

Here, the NDI indicates whether the current transmission is a repetition of the data, i.e., a retransmission, or something new. The receiver may combine the same data based on the NDI. The Tx Terminal ID indicates the ID of the transmitting terminal. The RV directive indicates the redundancy version by specifying different starting points in the circular buffer for reading the encoded buffer. Based on the RV indicator, the transmitting terminal can choose between different redundancy versions for iterations of the same packet. The MCS directive specifies the MCS level for D2D communication. Resource allocation indicates to which time/frequency physical resource the D2D data is allocated and transmitted. The power control instruction shall be a command for the terminal receiving the information to control the appropriate amount of power for the D2D transmission.

For a terminal supporting D2D communication, the radio resource for D2D communication may be the uplink channel of the (cellular) wireless communication system. In this case, the SA and data for D2D communication may be transmitted based on the PUSCH structure of the uplink physical channel of the wireless communication system, i.e., the PUSCH structure may be reused for the physical channel for D2D communication. For example, the physical channel for D2D communication may have a 24-bit Cyclic Redundancy Check (CRC) inserted, and turbo coding may be used. In addition, rate matching may be used for bit size matching and generating multiple transmissions. Scrambling may be used for interference randomization. PUSCH A demodulation reference signal (DMRS) may be used. The DMRS is used for channel estimation for coherent demodulation of the uplink received signal.

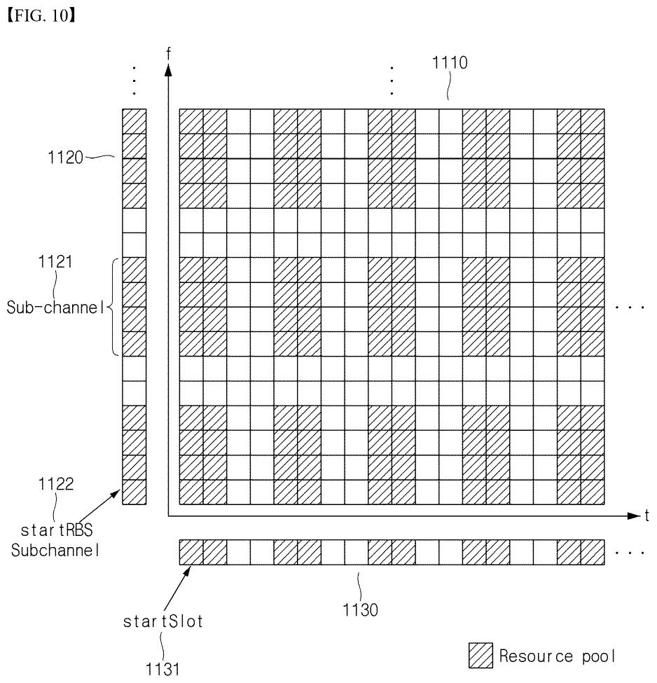

FIG. 9 is a diagram illustrating a system according to one embodiment of the present disclosure.

Referring to (a) of FIG. 9, all V2X terminals (UE-1, UE-2) are located within the coverage of the base station (gNB/eNB/RSU) (In-coverage scenario). All V2X terminals (UE-1, UE-2) can receive data and control information from the base station (gNB/eNB/RSU) via downlink (DL) or transmit data and control information to the base station via uplink (UL). The data and control information may be data and control information for V2X communication or data and control information for general cellular communication other than V2X communication. Also, in (a) of FIG. 9, the V2X terminals UE-1 and UE-2 may transmit and receive data and control information for V2X communication via a sidelink (SL).

Referring to (b) of FIG. 9, UE-1 of the V2X terminals is located within the coverage of the base station (gNB/eNB/RSU) and UE-2 is located outside the coverage of the base station (gNB/eNB/RSU) (partial coverage scenario). Referring to (b) of FIG. 9, the terminal UE-1 located within the coverage of the base station may receive data and control information from the base station via downlink (DL) or transmit data and control information to the base station via uplink (UL). Referring to (b) of FIG. 9, the terminal UE-2 located outside the coverage area of the base station cannot receive data and control information from the base station via downlink and cannot transmit data and control information to the base station via uplink. The terminal UE-2 can transmit and receive data and control information for V2X communication through the sidelink SL with the terminal UE-1.

FIG. 9 (c) shows a case where all V2X terminals (UE-1, UE2) are located outside the coverage area of the base station (gNB/eNB/RSU). Referring to (c) of FIG. 9, the terminals (UE-1, UE-2) cannot receive data and control information from the base station via downlink (DL), and cannot transmit data and control information to the base station via uplink (UL). On the other hand, the terminal UE-1 and the terminal UE-2 can transmit/receive data and control information for V2X communication through the sidelink SL.

FIG. 9 (d) illustrates a case where the V2X transmitting terminal and the V2X receiving terminal are connected to different base stations (gNB/eNB/RSU) (RRC connected state) or are camping (RRC disconnected state, i.e., RRC idle state) (inter-cell V2X communication). In this case, the UE-1 may be a V2X transmitting terminal and the UE-2 may be a V2X receiving terminal. Alternatively, the terminal UE-1 may be a V2X receiving terminal and the terminal UE-2 may be a V2X transmitting terminal. The UE-1 may receive a V2X-specific System Information Block (SIB) from the base station to which the UE-1 is connected (or where it is camped), and the UE-2 may receive a V2X-specific SIB from another base station to which the UE-2 is connected (or where it is camped). In this case, the information in the V2X-only SIB received by the UE-1 may be different from the information in the V2X-only SIB received by the UE-2. Therefore, in order to perform V2X communication between terminals located in different cells, it is necessary to unify the received SIB information.

In FIG. 9, a V2X system comprising two terminals (UE-1, UE-2) is illustrated as an example for ease of explanation, but without limitation, various numbers of terminals may participate in the V2X system. Furthermore, the uplink (UL) and downlink (DL) between the base station (eNB/gNB/RSU) and the V2X terminals (UE-1, UE2-) may be named as Uu interfaces, and the sidelink (SL) between the V2X terminals (UE-1, UE-2) may be named as PC5 interfaces. Therefore, they may be used interchangeably in the present disclosure.

In the present disclosure, a terminal may refer to a vehicle supporting vehicle-to-vehicle (V2V) communication, a vehicle supporting vehicle-to-pedestrian (V2P) communication, a handset (e.g., smartphone) of a vehicle or pedestrian supporting vehicle-to-pedestrian (V2P) communication, a vehicle supporting vehicle-to-network (V2N) communication, or a vehicle supporting vehicle-to-infrastructure (V2I) communication. As used herein, a terminal may also refer to a roadside unit (RSU) equipped with terminal functionality, an RSU equipped with base station functionality, or an RSU equipped with some of the base station functionality and some of the terminal functionality.

In the present disclosure, a sidelink control channel may be referred to as a physical sidelink control channel (PSCCH), and a sidelink shared channel or data channel may be referred to as a physical sidelink shared channel (PSSCH). In addition, the broadcast channel that is broadcast with the synchronization signal may be referred to as the physical sidelink broadcast channel (PSBCH), and the channel for feedback transmission may be referred to as the physical sidelink feedback channel (PSFCH). However, either PSCCH or PSSCH may be used for feedback transmission. Depending on the communication system, it may be referred to as LTE-PSCCH, LTE-PSSCH, NR-PSCCH, NR-PSSCH, etc. In the present disclosure, a sidelink may refer to a link between terminals and a Uu link may refer to a link between a base station and a terminal.

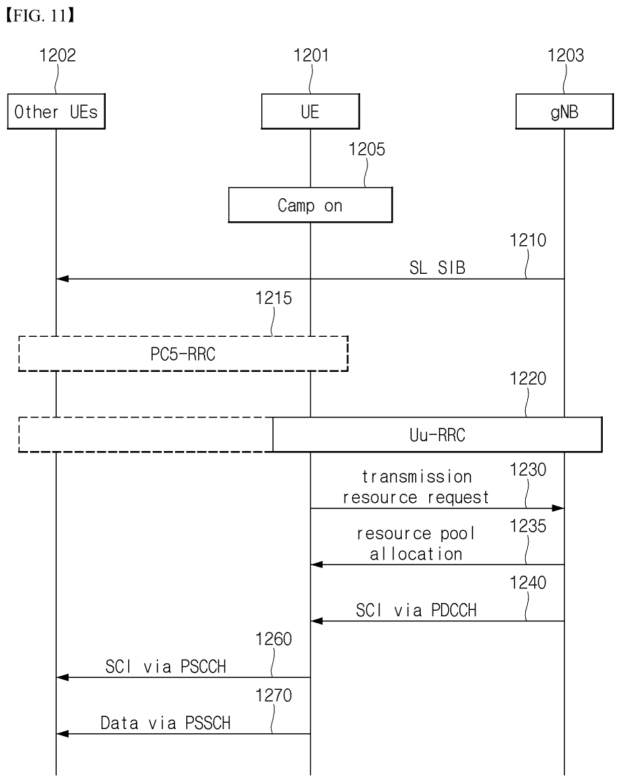

FIG. 10 is a diagram for illustrating a resource pool, defined as a set of resource resources in time and frequency used for transmitting and receiving sidelinks according to one embodiment of the present disclosure.

Referring now to 1110 of FIG. 10, a case where a resource pool is allocated discontinuously over time and frequency is illustrated. While the present disclosure focuses on the case where the resource pool is allocated discontinuously in frequency, it is understood that the resource pool may be allocated continuously in frequency.

Referring to 1120 of FIG. 10, a discontinuous resource allocation over frequency may be accomplished. The granularity of the resource allocation over frequency may be a physical resource block (PRB).

Further, referring to 1121 of FIG. 10, the resource allocation over frequency may be based on a sub-channel. A sub-channel may be defined as a unit of resource allocation on a frequency comprising a plurality of RBs. Specifically, a sub-channel may be defined as an integer multiple of RBs. Referring to 1121 of FIG. 10, a case is illustrated where a subchannel is sized to consist of four contiguous PRBs. Subchannels may be sized differently, and while it is common for a subchannel to be composed of consecutive PRBs, it is not required that a subchannel be composed of consecutive PRBs. A subchannel may be the basic unit of resource allocation for a Physical Sidelink Shared Channel (PSSCH) or Physical Sidelink Control Channel (PSCCH), and the size of the subchannel may be set differently depending on whether the channel is a PSSCH or PSCCH. Note also that a subchannel may be referred to as a Resource Block Group (RBG). The following describes methods for allocating a non-contiguous resource pool over a frequency and dividing the allocated resource pool into a plurality of subchannels.

Referring to 1122 of FIG. 10, startRBSubchanel may indicate a starting position of a subchannel on a frequency in the resource pool.

A resource block, which is a frequency resource belonging to a resource pool for PSSCH in an LTE V2X system, may be determined in a manner as shown in Table 5 below.

TABLE 5

| | |
|---|---|
| - | The resource block pool consists of N_{subCH} sub-channels where N_{subCH} is given by higher layer |
| | parameter numSubchannel. |
| - | The sub-channel m for m = 0,1,...,N_{subCH} − 1 consists of a set of n_{subCHsize} contiguous resource |
| | blocks with the physical resource block number n_{PRB} = n_{subCHRBstart} + m * n_{subCHsize} + j for |
| | j = 0,1,...,n_{subCHsize} − 1 where n_{subCHRBstart} and n_{subCHsize} are given by higher layer parameters |
| | startRBSubchannel and sizeSubchannel, respectively |

1130 of FIG. 10 illustrates a case where the resource allocation is discontinuous in time. The granularity of the temporal resource allocation may be a slot. While the present disclosure focuses on the case where the resource pool is allocated discontinuously in time, it is of course possible for the resource pool to be allocated continuously in time.

Referring to 1131 of FIG. 10, startSlot may indicate a starting position of a slot in the resource pool in time.

A subframe, which is a temporal resource belonging to a resource pool for PSSCH in an LTE V2X system, may be determined in a manner as shown in Table 6 below.

```
TABLE 6
- 0 ≤ [symbol]  < 10240,
- the subframe index is relative to subframe#0 of the radio frame corresponding to SPN 0 of the serving
  cell or DFN 0 (described in [11]),
- the set includes all the subframes except the following subframes,
  - subframes in which SLSS resource is configured,
  - downlink subframes and special subframes if the sidelink transmission occurs in a TDD cell,
  - reserved subframes which are determined by the following steps:
      1) the remaining subframes excluding N [symbol]   and N [symbol]   subframes from the set of all the
          subframes are denoted by (l₀, 1₁, ... , 1 [symbol]  ) arranged in increasing order of subframe
          index, where N [symbol]   is the number of subframes in which SLSS resource is configured within
          10240 subframes and N [symbol]   is the number of downlink subframes and special subframes within
          10240 subframes if the sidelink transmission occurs in a TDD cell.
      2) a subframe l [symbol]  (0 ≤ r < (10240 − N [symbol]   − N [symbol]  )) belongs to the reserved subframes if
          $r = ⌊ \frac{m \cdot ( 10240 - \text{?} - \text{?} )}{\text{?}} ⌋ where m = 0 , … , \text{?} - 1 and$
          N_{reserved} = (10240 − N [symbol]   − N [symbol]  )mod L_{bitmap}. Here, L_{bitmap} the length of the bitmap is
          configured by higher layers.
- the subframes are arranged in increasing order of subframe index.
- A bitmap (b₀, b₁, ... , b_{L}_{_{bitmap}}₋₁) associated with the resource pool is used where L_{bitmap} the length of
  the bitmap is configured by higher layers.
$‐ A subframe \text{?} ( 0 \leq k < ( 10240 - N \text{?} - N \text{?} - N \text{?} ) ) belongs to the subframe pool if$
  b_{k′} = 1 where k′ = k mod L_{bitmap}. [symbol]
indicates data missing or illegible when filed
```

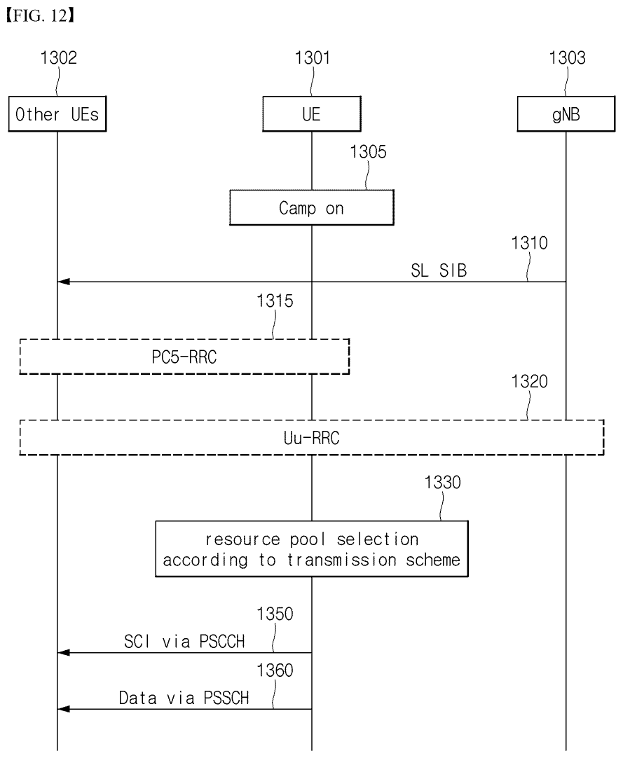

FIG. 11 is a flow diagram to illustrate a scheduled resource allocation (mode 1) method in a sidelink according to one embodiment of the present disclosure.

The scheduled resource allocation (mode 1) method is a method in which a base station allocates resources used for sidelink transmission to RRC-connected terminals in a dedicated scheduling manner. The Scheduled resource allocation (mode 1) method is effective for interference management and resource pool management because the base station can manage the resources of the sidelink.

Referring to FIG. 11, the terminal 1201 that is camping on 1205 may receive SL SB (Sidelink System Information Bit) 1210 from the base station 1203. The system information may include resource pool information for transmission and reception, setting information for sensing behavior, information for setting motivation, information for inter-frequency transmission and reception, and the like. Once the terminal 1201 has generated data traffic for V2X, it can perform an RRC connection with the base station 1220. The RRC connection between the terminal and the base station may be referred to as Uu-RRC 1220. The Uu-RRC connection may be performed prior to the generation of data traffic for V2X. The terminal 1201 may request transmission resources from the base station 1203 to enable V2X communication with other terminals 1202 1230. At this time, the terminal 1201 may request transmission resources from the base station 1203 to enable V2X communication using RRC messages or MAC CEs (1230). Here, the RRC message may be a SidelinkUEInformation, UEAssistanceInformation message. The MAC CE may be a buffer status report MAC CE in a new format, such as a buffer status report MAC CE that includes at least an indicator that it is a buffer status report for V2X communication and information about the size of the data buffered for D2D communication. The detailed format and content of the buffer status report used by 3GPP can be found in 3GPP standard TS36.321 E-UTRA MAC Protocol Specification. The base station 1203 may allocate V2X transmission resources to the terminal 1201 via a dedicated Uu-RRC message. The dedicated Uu-RRC message may be included in the RRCConnectionReconfiguration message. The resources allocated may be V2X resources over Uu or resources for PC5, depending on the type of traffic requested by the terminal 1201 or whether the link is congested. For resource allocation decisions, the terminal may additionally send the ProSe Per Packet Priority (PPPP) or Logical Channel ID (LCID) information of the V2X traffic via UEAssistanceInformation or MAC CE. Since the base station 1203 also has information about the resources utilized by the other terminals 1202, it can allocate the remaining pool of resources requested by the terminal 1201 (12-35). The base station 1203 may instruct the terminal 1201 for final scheduling with a DCI transmission over PDCCH (1240).

In the case of broadcast transmission, the terminal 1201 may broadcast SCI (Sidelink Control Information) to other terminals 1202 over PSCCH as a broadcast without establishing an RRC for additional sidelinks 1270, and may also broadcast data to other terminals 12-02 over PSSCH 1270.

In contrast, in the case of unicast and groupcast transmissions, the terminal 1201 may perform RRC connections with other terminals 1202 on a one-to-one basis. Here, the terminal-to-terminal RRC connection may be named PC5-RRC to distinguish it from Uu-RRC. Even in the case of a groupcast, the PC5-RRC 1215 may be individually connected between terminals and terminals in the group. In FIG. 11, the association of the PC5-RRC 1215 is shown as an operation after the transmission 1210 of the SL SIB, but it can be performed at any time before the transmission 1210 of the SL SIB or before the transmission 1260 of the SCI. If an RRC connection is required between the terminal and the sidelink, the sidelink's PC5-RRC connection (1215) may be established and the Sidelink Control Information (SCI) may be transmitted unicast or groupcast to other terminals (1202) via PSCCH (1260). In this case, a groupcast transmission of SCI may be interpreted as a group SCI. Additionally, data may be transmitted unicast or groupcast to other terminals 1202 via PSSCH (1270).

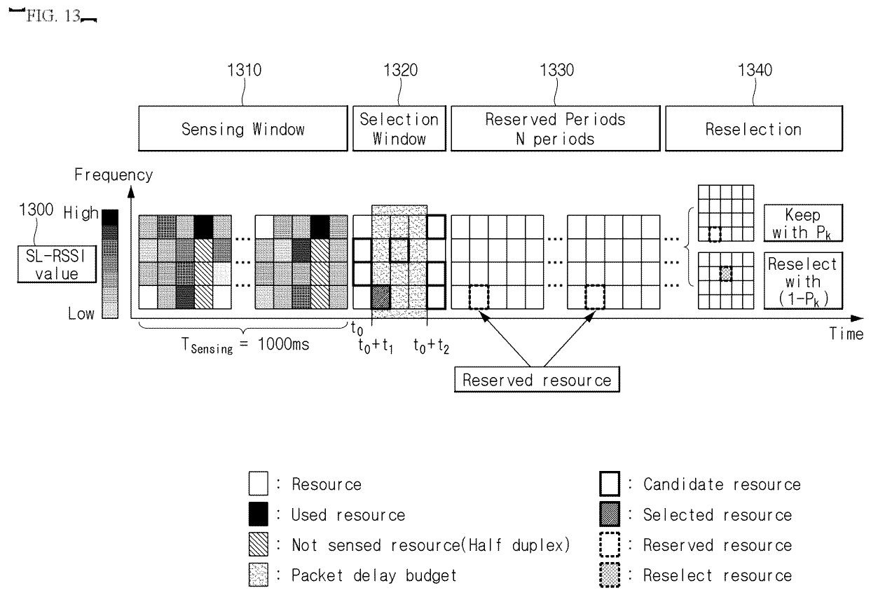

FIG. 12 is a flow diagram to illustrate a UE autonomous resource allocation (mode 2) method in a sidelink according to one embodiment of the present disclosure.

In the UE autonomous resource allocation (mode 2) method, the base station 1303 provides a pool of sidelink transmission and reception resources for V2X as system information, and the terminal 1301 may select a transmission resource according to a predetermined rule. The resource selection method may include zone mapping, sensing-based resource selection, random selection, etc. In contrast to the scheduled resource allocation (mode 1) method, where the base station 1303 is directly involved in resource allocation, FIG. 12 differs from the scheduled resource allocation (mode 1) method in that the terminal 1301 autonomously selects resources and transmits data based on a pool of resources received in advance via system information. In V2X communication, the base station 1303 may allocate different types of resource pools (V2V resource pool, V2P resource pool) for the terminal 1301. The allocatable resource pools may comprise resource pools in which the terminal 1301 can autonomously select an available resource pool after sensing the resources used by other nearby terminals 1302, and resource pools in which the terminal 1301 randomly selects resources from a preset resource pool.

The terminal 1301 that is camping on 1305 may receive 1310 a Sidelink System Information Bit (SL SIB) from the base station 1303. The system information may include resource pool information for transmitting and receiving, setting information for sensing behavior, information for setting motivation, information for inter-frequency transmitting and receiving, and the like. A difference in operation between FIG. 11 and FIG. 12 is that in FIG. 11, the base station 1203 and the terminal 1301 operate in an RRC-connected state, whereas in FIG. 12, the base station 1203 and the terminal 1301 may also operate in an RRC-unconnected idle mode 1320. Further, in the RRC-unconnected idle mode 1320, the base station 1303 may operate to allow the terminal 1301 to autonomously select transmission resources without directly engaging in resource allocation. When the terminal 1301 generates data traffic for V2X, the terminal 1301 may select a resource pool in the time/frequency domain from among the resource pools communicated via system information from the base station 1303, according to a set transmission behavior.

Next, in the case of a broadcast transmission, the terminal 1301 may broadcast SCI (Sidelink Control Information) to the other terminals 1302 via PSCCH as a broadcast without setting the RRC of an additional sidelink (1350). In addition, the terminal 1301 may broadcast data to the other terminals 1302 via PSSCH (1360).

In contrast, for unicast and groupcast transmissions, the terminal 1301 may perform RRC connections with other terminals 1302 on a one-to-one basis. Here, terminal to terminal RRC connections may be referred to as PC5-RRC, as distinguished from Uu-RRC. Even in the case of a groupcast, PC5-RRCs may be individually established between terminals in a group and terminals in the group. This can be analogized to the RRC layer connections in the connections between the base station and the terminal in NR uplinks and downlinks, and the connections at the RRC layer level in sidelinks can be called PC5-RRC. The PC5-RRC connection may be used to exchange UE capability information between terminals for the sidelink, or to exchange configuration information required to transmit and receive signaling. In FIG. 12, the connection of the PC5-RRC 1315 is shown as an operation after the SL SIB transmission 13-10, but it may be performed at any time before the SL SIB transmission 13-10 or before the SCI transmission 13-50. If an RRC connection is required between the terminals, the PC5-RRC connection of the sidelink can be performed (1315) and Sidelink Control Information (SCI) can be sent unicast or groupcast to other terminals (1302) via PSCCH (1350). In this case, a groupcast transmission of SCI may be interpreted as a group SCI. In addition, data may be transmitted unicast and groupcast to other terminals 1302 via PSSCH (1360).

In the present disclosure, a transmitting terminal (TX UE) may be a terminal that transmits data to a (target) receiving terminal (RX UE). For example, the TX UE may be a terminal that performs PSCCH and/or PSSCH transmissions. and/or the TX UE may be a terminal that transmits SL CSI-RS and/or SL CSI report request indicator to the (target) RX UE. And/or, the TX UE may be a terminal that transmits a (control) channel (e.g., PSCCH, PSSCH, etc.) and/or a reference signal (e.g., DM-RS, CSI-RS, etc.) on the (control) channel to be used for SL RLM and/or SL RLF operation of the (target) RX UE.

Furthermore, in the present disclosure, the receiving terminal (RX UE) may be a terminal that transmits SL HARQ feedback to the TX UE based on (i) the success of decoding the data received from the transmitting terminal (TX UE) and/or (ii) the success of detecting/decoding the PSCCH transmitted by the TX UE (related to PSSCH scheduling). and/or the RX ULE may be the terminal that performs the SL CSI transmission to the TX UE based on the SL CSI-RS and/or SL CSI report request indicator received from the TX UE. and/or the RX UE may be the terminal that transmits the measured SL(L1) RSRP measurement value to the TX UE based on the (predefined) reference signal received from the TX UE and/or the SL(L1) RSRP report request indicator. and/or the RX UE may be a terminal that transmits the RX UE's own data to the TX UE. and/or, the RX UE may be a terminal that performs SL RLM and/or SL RLF operations based on a (preset) (control) channel received from the TX UE and/or a reference signal on the (control) channel.

In the present disclosure, for example, when the RX UE transmits SL HARQ feedback information for PSSCHs and/or PSCCHs received from the TX UE, the method below or some of the methods below may be contemplated. Here, for example, the method below or some of the methods below may be applied restrictively only when the RX UE has successfully decoded/detected the PSCCH that schedules the PSSCH.

Option 1) The NACK information may be sent to the TX UE only if the RX UE fails to decode/receive the PSSCH received from the TX UE.

Option 2) If the RX UE succeeds in decoding/receiving the PSSCH received from the TX UE, it may transmit ACK information to the TX UE, and if it fails to decode/receive the PSSCH, it may transmit NACK information to the TX UE.

In some embodiments of the present disclosure, for example, the TX UE may transmit the following information or some of the following information to the RX UE via SCI. Here, for example, the TX UE may transmit some or all of the below information to the RX UE via a first SCI (FIRST SCI) and/or a second SCI (SECOND SCI).

PSSCH (and/or PSCCH) related resource allocation information (e.g., time/frequency resource location/number, resource reservation information (e.g., period))

SL CSI Report Request Indicator or SL (L1) RSRP (and/or SL (L1) RSRQ and/or SL (L1) RSSI) Report Request Indicator

SL CSI transmission indicator (on PSSCH) (or SL (L1) RSRP (and/or SL (L1) RSRQ and/or SL (L1) RSSI) information transmission indicator)

MCS information

TX POWER information

L1 DESTINATION ID information and/or L1 SOURCE ID information

SL HARQ PROCESS ID information

NDI information

RV information

QoS information (related to the transmitted TRAFFIC/PACKET) (e.g., PRIORITY information)

SL CSI-RS transmit indicator or number of SL CSI-RS antenna ports (transmitted) information

TX UE location information or location (or distance area) information of the target RX UE (for which SL HARQ feedback is requested)

Reference signal (e.g., DM-RS, etc.) information relevant to the decoding (and/or channel estimation) of data transmitted over PSSCH. For example, it may be information related to the pattern of the (time-frequency) mapping resources of the DM-RS, RANK information, antenna port index information, etc.

Further, in the present disclosure, the TX UE may transmit the SCI, the first SCI (FIRST SCI), and/or the second SCI (SECOND SCI) to the RX UE via the PSCCH, such that the PSCCH may be replaced/substituted with (i) the SCI and/or (ii) the FIRST SCI and/or (iii) the SECOND SCI. and/or SCI may be replaced/substituted by PSCCH and/or FIRST SCI and/or SECOND SCI. And/or, since the TX UE may transmit the SECOND SCI to the RX UE via PSSCH, the PSSCH may be replaced/replaced with the SECOND SCI.

In the present disclosure, for example, where the SCI configuration fields are divided into two groups in consideration of the (relatively) high SCI payload size, the first SCI comprising the first group of SCI configuration fields may be referred to as the FIRST SCI, and the second SCI comprising the second group of SCI configuration fields may be referred to as the SECOND SCI. Further, for example, the FIRST SCI may be transmitted to the receiving terminal via PSCCH. Furthermore, for example, the SECOND SCI may be transmitted to the receiving terminal via an (independent) PSCCH or piggybacked with data via PSSCH.

As used herein, for example, “setting” or “defining” may refer to a (resource pool specific) (PRE)CONFIGURATION from a base station or network (via predefined signaling (e.g., SIB, MAC, RRC, etc.)).

In some aspects of the present disclosure, for example, RLF may be determined based on an OUT-OF-SYNCH (OOS) indicator or an IN-SYNCH (IS) indicator, and thus may be replaced/substituted with OUT-OF-SYNCH (OOS) or IN-SYNCH (IS).

In the present disclosure, for example, RB may be replaced/substituted with SUBCARRIER. Also, in the present disclosure, for example, PACKET or TRAFFIC may be replaced by TB or MAC PDU, depending on the layer at which it is transmitted.

In one aspect of the disclosure, CBG or CG may be substituted/replaced with TB.

In the present disclosure, for example, the SOURCE ID may be replaced/replaced by the DESTINATION ID.

In the present disclosure, for example, an L1 ID may be replaced/substituted with an L2 ID. For example, the L1 ID may be an L1 SOURCE ID or an L1 DESTINATION ID. For example, the L2 ID may be an L2 SOURCE ID or an L2 DESTINATION ID.

In the following, methods for performing the sidelink transmission proposed in the present disclosure will be described in detail.

A wireless network that can be widely deployed may implement the concept of a “connected vehicle”. The two main technologies used to build automotive networks are Wi-Fi technology and cellular networks. A Wi-Fi-based standard designed specifically for vehicular communications was approved in 2010 under the name IEEE 802.11p, while 3GPP defines a standard technology called Cellular Vehicle-to-Everything (C-V2X). The term V2X can refer to vehicle-to-vehicle (V2V), vehicle-to-pedestrian (V2P), vehicle-to-infrastructure (V2I), and vehicle-to-network (V2N) communications. The long-term evolution (LTE)-V2X standard was defined in Release 14 and supports Mode 3 and Mode 4 resource allocation schemes.

Mode 4 uses Sensing-Based Semi-Persistent Scheduling (SB-SPS) to enable user equipment (UE) to automatically select resources based on channel sensing, and the UE can reuse these resources for multiple consecutive cycles. Afterward, the vehicular UE (VUE) can either keep these resources with a reselection probability of P_k or reselect new resources with probability (1−P_k). In the conventional SB-SPS algorithm, the value of P_k is set to be the same for all UEs in a given scenario. However, the same reselection probability for all UEs may not meet the service requirements at times other than when the reselection probability is set. More specifically, a low value of P_k means that the terminal has a higher probability of reselecting a resource; if the VUE uses a resource with low interference and the P_k value is set low, the low value of P_k will cause the VUE to perform unnecessary resource reselection. In addition, a high P_k value means that the terminal has a lower probability of reselecting a resource, and if the P_k value is set equally high for all VUEs, the VUEs will be more likely to use resources with high interference values. In other words, a fixed P_k value setting does not account for changing channel conditions. In other words, the fixed reselection probability cannot meet the frequently updated channel requirements, and users need to independently adjust the reselection probability value based on the real-time CSI to improve the communication efficiency. Based on this need, the present disclosure proposes a method for a VUE to set/update/reset a P_k value in real time based on CSI.

Before describing the specifics, a description of the sensing-based resource (re)selection behavior is provided to help understand the method proposed in this disclosure.

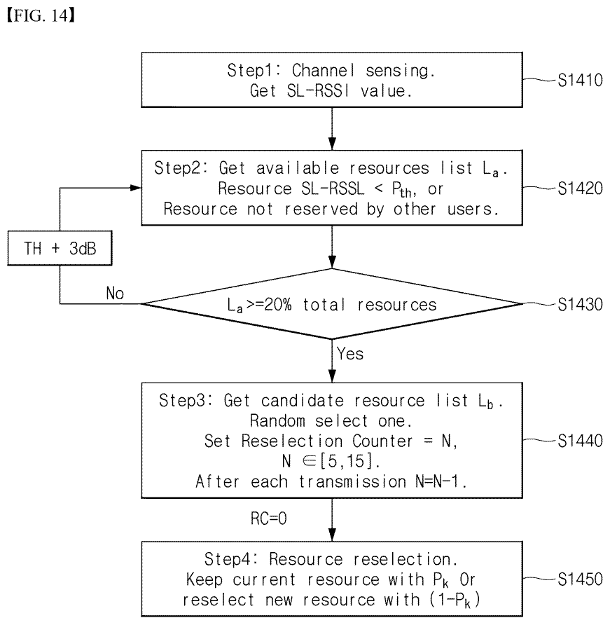

FIG. 13 is a diagram illustrating an example of a resource reselection behavior of a terminal in a sidelink communication. The SL-RSSI value measured over the resource grid in the resource area/resource pool shown in FIG. 13 is shown as 1300. First, the terminal performs a sensing operation 1310 based on the sensing window. The sensing enables the terminal to identify candidate resources that can be used for sidelink transmission, and resource selection among the identified/identified candidate resources is performed in a selection window 1320. The reserved period(s) are then indicated (1330), and resource reselection is performed (1340) based on a resource reselection probability of P_k.

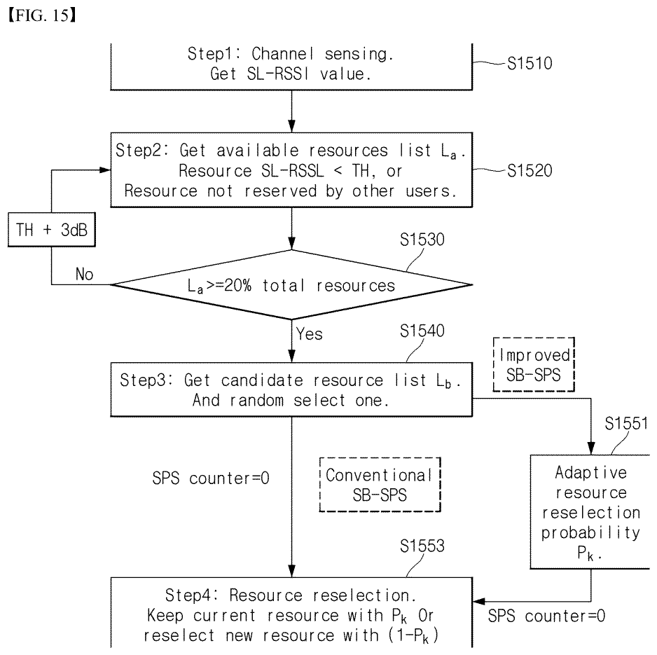

FIG. 14 is a flowchart illustrating one example of resource reselection behavior of a terminal in sidelink communication.

First, the terminal performs channel sensing to obtain SL-RSSI (Sidelink Received Signal Strength Indicator) values for resources on the channel (S1410). Then, the terminal obtains a list of resources (La) available for sidelink transmission (S1420). Here, the resources included in the list of available resources may be resources (i) whose SL-RSSI values are less than a predefined threshold (P_th) value, or (ii) not reserved by other terminals (users). The terminal then determines (S1430) whether the ratio value of the resources included in the list of available resources to the total resources (in the resource pool) is greater than or equal to 20%. If the ratio value of the resources included in the list of available resources to the total resources (in the resource pool) is less than 20%, the threshold value is updated to the predefined threshold value plus 3 dB, and steps S1420 and S1430 are performed again. Conversely, if the ratio value of the resources included in the list of available resources to the total resources (in the resource pool) is 20% or more, one of the resources included in the list of available resources is randomly selected (S1440). In this case, the value of the resource reselection counter (RC) may be set to N, wherein the value of N may have a natural number value within a range of 5 or more and 15 or less. The value of the resource reselection counter may be decremented by one after each sidelink transmission of the terminal. Next, when the value of the reselection counter becomes zero, the terminal performs a resource reselection based on the resource reselection probability of P_k (S1450). More specifically, the probability that the terminal continues to use the preselected resource for sidelink transmission is P_k, and the probability of reselecting a resource other than the preselected resource may be 1-P_k. In the present disclosure, performing a resource reselection may not always mean that the resource is actually reselected, i.e., performing a resource reselection may refer to an action where the terminal determines whether to continue using the preselected resource or select a new resource using the resource reselection probability P_k value. In the case of FIG. 14, the range of available RC counter values [5,15] and the resource reselection probability P_k value may be fixed values.

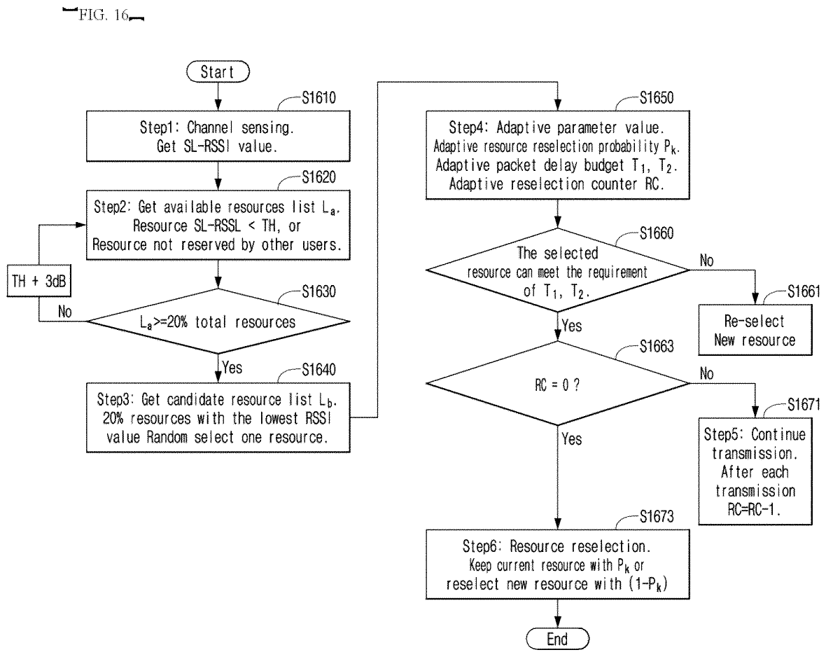

FIG. 15 is a flow diagram illustrating one example of resource reselection behavior of a terminal in sidelink communication. More specifically, FIG. 15 illustrates the difference between the resource reselection behavior of the terminal previously described in FIG. 14 and the resource reselection behavior proposed in the present disclosure. Referring to FIG. 15, first, the terminal performs channel sensing to obtain SL-RSSI values for resources on the channel (S1510). Then, the terminal obtains a list of available resources (La) for sidelink transmission (S1520). Here, the resources included in the list of available resources may be resources whose SL-RSSI values are (i) less than a predefined threshold (P_th) value, or (ii) not reserved by other terminals (users). The terminal then determines (S1530) whether the ratio value of the resources included in the list of available resources to the total resources (in the resource pool) is greater than or equal to 20%. If the ratio value of the resources included in the list of available resources to the total resources (in the resource pool) is less than 20%, the threshold value is updated to the predefined threshold value plus 3 dB, and steps S1520 and S1530 are performed again. Conversely, if the ratio value of the resources included in the list of available resources to the total resources (in the resource pool) is 20% or more, one of the resources included in the list of available resources is randomly selected (S1540). At this time, according to the resource reselection method of FIG. 14, a value of the resource reselection counter (RC) may be set to N, wherein the value of N may have a natural number value within a range of 5 or more and 15 or less, and the value may be a fixed value. The value of the resource reselection counter may be decremented by one after each sidelink transmission of the terminal. Then, in the case of the operation described in FIG. 14, when the value of the reselection counter becomes zero, the terminal performs resource reselection (S1553) based on the resource reselection probability of Pk. In this case, in the case of the behavior described in FIG. 14, the value of Pk may be a fixed value. In contrast, for the resource reselection method proposed in the present disclosure, the P_k value may be updated (S1551). Further, although not shown in FIG. 15, the range of available RC counter values may also be changed. In FIG. 15, the probability that the terminal continues to use the preselected resource for sidelink transmission is P_k, and the probability of reselecting a resource other than the preselected resource may be 1-P_k.

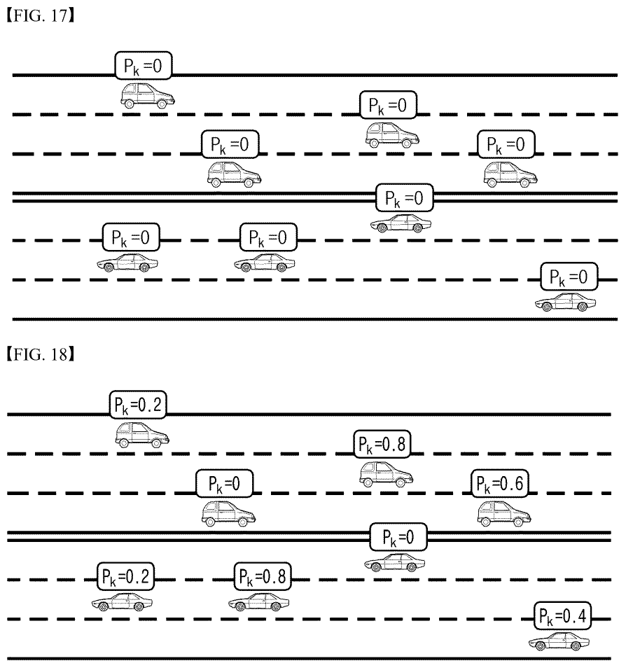

FIG. 16 is a flow diagram illustrating another example of resource reselection behavior of a terminal in a sidelink communication. More specifically, FIG. 16 illustrates resource reselection behavior of a terminal based on how at least one parameter associated with resource reselection is updated/reset. In FIG. 16, the at least one parameter associated with resource reselection may be (i) a resource reselection probability value, (ii) a packet delay budget (PDB) indicating a maximum time that a delay in the sidelink transmission can be tolerated, or (iii) a reselection counter value associated with a determination of whether to perform resource reselection.

Referring to FIG. 16, first, the terminal performs channel sensing to obtain SL-RSSI values for resources on the channel (S1610). Then, the terminal obtains a list of available resources (L_a) for sidelink transmission (S1620). Here, the resources included in the list of available resources may be resources whose SL-RSSI values are (i) less than a predefined threshold (P_th) value, or (ii) not reserved by other terminals (users). The terminal then determines (S1630) whether the ratio value of the resources included in the list of available resources to the total resources (in the resource pool) is greater than or equal to 20%. If the ratio value of the resources included in the list of available resources to the total resources (in the resource pool) is less than 20%, the threshold value is updated to the predefined threshold value plus 3 dB, and steps S1620 and S1630 are performed again. Conversely, if the ratio value of the resources included in the list of available resources to the total resources (in the resource pool) is 20% or more, one of the resources included in the list of available resources is randomly selected (S1640). In this case, the resources included in the list of available resources may be resources that are in the bottom 20% of all resources having a low RSSI value. Subsequently, the at least one parameter associated with the resource reselection is updated/reset (S1650). After the at least one parameter associated with the resource reselection is updated/reset, the device determines whether the resource selected in step S1640 is a resource that satisfies the packet delay budget (PDB) (S1660). If, as a result of the judgment, the resource selected in step S1640 is a resource that does not satisfy the PDB, a resource reselection (S1661) is performed. On the other hand, if the resource selected in step S1640 is a resource that satisfies the PDB, determine whether the reselection counter value is zero (S1663). If the reselection counter value is not zero, the device performs a sidelink transmission on the selected resource, in which the reselection counter value is decremented by one after each sidelink transmission of the device. Conversely, if the reselection counter value is 0, the terminal performs resource reselection based on the resource reselection probability of P_k (S1673). In this case, the probability that the terminal continues to use the preselected resource for the sidelink transmission is P_k, and the probability of reselecting a resource other than the preselected resource may be 1-P_k.

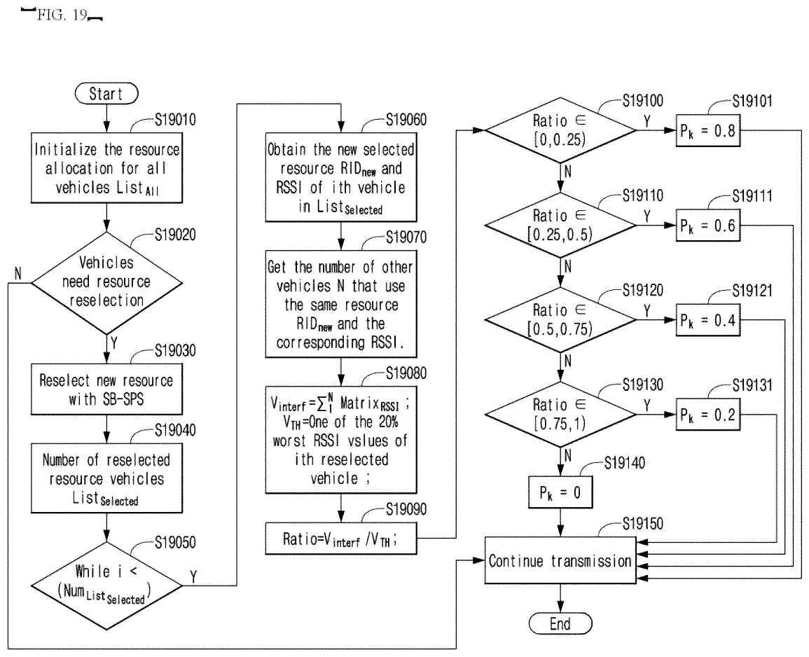

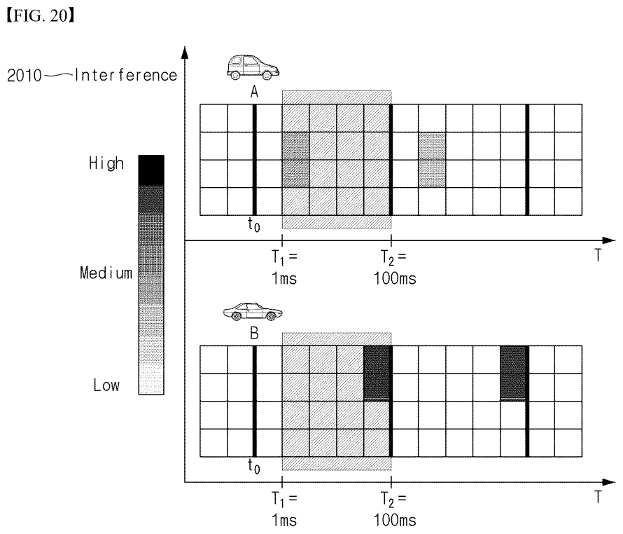

FIGS. 17 and 18 are illustrations of an example scenario in which the resource reselection method proposed in the present disclosure is performed. Referring to FIG. 17, it can be seen that the resource reselection probability P_k is set to the same value (0) for all terminals (vehicles). When P_k is set to 0, the terminal will always select a new resource that is different from the previously selected resource as a result of performing resource reselection. Referring to FIG. 18, it can be seen that the value of the resource reselection probability resource reselection probability P_k of each terminal is set differently as the method proposed in the present disclosure is applied. The resource reselection probability setting values illustrated in FIGS. 17 and 18 are only examples, and the method proposed in the present disclosure is not to be construed as being limited to the examples in FIGS. 17 and 18.

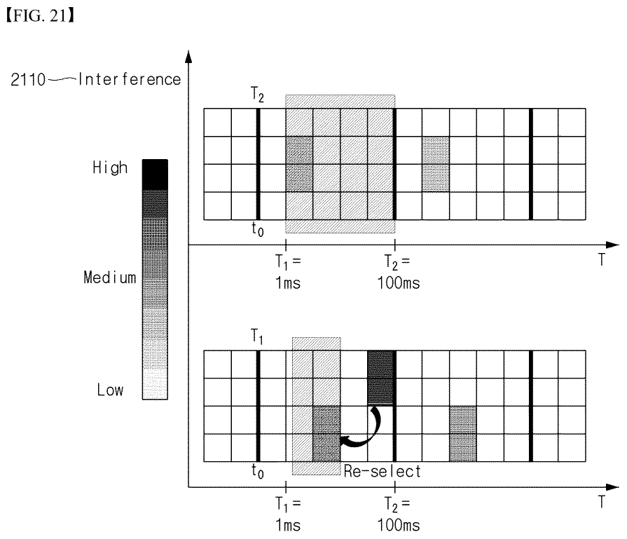

FIG. 19 is a flow diagram illustrating one example of how the resource reselection method proposed herein is performed. More specifically, FIG. 19 illustrates an operation in which a resource reselection probability is updated among parameters associated with resource reselection.

Referring to FIG. 19, a resource allocation list (List all) for all terminals (vehicles) participating in the sidelink communication is initialized (S19010). At this time, the resource allocation list (List all) for all the terminals (vehicles) may include information about the number of all the terminals. The terminal then determines whether a resource reselection is required (S19020). If it is determined that resource reselection is not required, the terminal continues to perform the sidelink transmission (S19150). Conversely, if it is determined that resource reselection is required, the device selects a new resource (S19030). At this time, a list of the terminals that have performed the resource reselection may be set (S19040). To set the list of the terminals that have performed the resource reselection, the terminal may receive configuration information from the base station including information about the list of the terminals that have performed the resource reselection, and the configuration information may be transmitted via upper layer signaling. Thereafter, the terminal obtains an identifier (RID_new) for the (re)selected resource and, based on the list of terminals that have performed the resource reselection, measures the RSSI values on the resources that have been reselected by other terminals (S19050, S19060).

Next, the terminal obtains the number (N) of other terminals using the same resource (RID_new) as the resource (re)selected by the terminal, and obtains the RSSI value on the resource (RID_new) (S19070). Then, the terminal obtains a V_interf value calculated as a sum of the RSSI matrices corresponding to the other terminals using the same resource as the (re)selected resource (RID_new) measured on the (re)selected resource (RID_new), and a V_TH value set to one of the RSSI values corresponding to the bottom 20% of the RSSI values measured in step S19060 is determined (S19080). Based on the V_interf value and the V_TH value calculated in step S19080, a specific ratio value (Ratio) for updating the resource reselection probability value is calculated (S19090). Generalizing this, it may be understood that resource reselection parameters associated with the resource reselection are reset based on a specific ratio value, which is calculated by dividing (i) a sum of received signal strength indicator (RSSI) matrices obtained based on signals received respectively from terminals using same resource as the reselected specific resource by (ii) a value of one of matrices corresponding to a lower specific ratio of all RSSI matrices obtained based on signals received respectively from all terminals participating in the sidelink communication. Subsequently, the resource reselection probability value is updated/reset via steps S19100 to S19140. More specifically, if the specific ratio value is greater than 0 and less than 0.25 (S19100), the reselection probability value may be reset to have a value of 0.8 (S19101). After resetting the reselection probability, the terminal may continue the sidelink transmission. If the specific ratio value is greater than or equal to 0.25 and less than or equal to 0.5 (S19110), the reselection probability value may be reset to have a value of 0.6 (S19111). After resetting the reselection probability, the terminal may continue the sidelink transmission. If the specific ratio value is greater than or equal to 0.5 and less than or equal to 0.75 (S19120), the reselection probability value may be reset to have a value of 0.4 (S19121). After resetting the reselection probability, the terminal may continue the sidelink transmission. If the specific ratio value is greater than 0.75 and less than 1 (S19130), the reselection probability value may be reset to have a value of 0.2 (S19131). After resetting the reselection probability, the terminal may continue the sidelink transmission. Finally, if the specific ratio value is 1, the reselection probability value may be reset to have a value of 0 (S19140). After resetting the reselection probability, the terminal may continue the sidelink transmission. Generalizing, it may be understood that the specific ratio value may be a value from among (i) a value within a predefined range that is equal to or greater than zero and less than one, and (ii) a value outside the predefined range, wherein the predefined range includes at least one sub-range. Further, it may be understood that a mapping relationship between the at least one sub-range and the resource reselection probability value having a non-zero value is predefined, and that the specific ratio value having a value outside the predefined range is mapped to the resource reselection probability value having a value of zero.

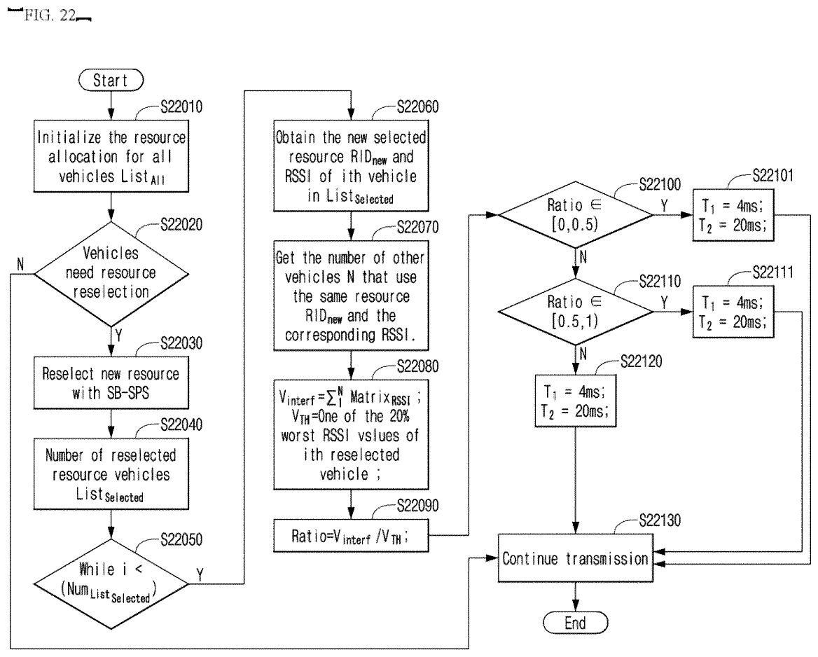

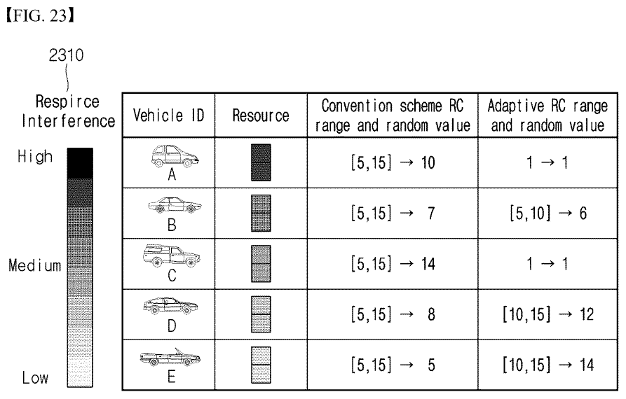

FIGS. 20 and 21 are illustrations of an example scenario in which a resource reselection method proposed in the present disclosure is performed. FIGS. 20 and 21 illustrate a case where the parameter associated with resource reselection is a PDB. Referring to FIG. 20, it can be seen that the PDB is set identically for all terminals (vehicles) A and B participating in the sidelink communication, i.e., in FIG. 20, the timing value T1 for the start and the timing value T2 for the end of the time interval associated with the PDB in the time resource are set identically for all terminals A and B to 1 ms and 100 ms, respectively. On the other hand, referring to FIG. 21, it can be seen that the PDB may be set to different values for the terminals (vehicles) A and B participating in the sidelink communication as the method proposed in the present disclosure is applied. More specifically, in the case of FIG. 21, the timing values T1 for the beginning and T2 for the end of the time interval associated with the PDB in the time resource may be set to 1 ms and 100 ms, respectively, for the one terminal shown in FIG. 21, but may be set to 4 ms and 20 ms, respectively, for the other terminal.

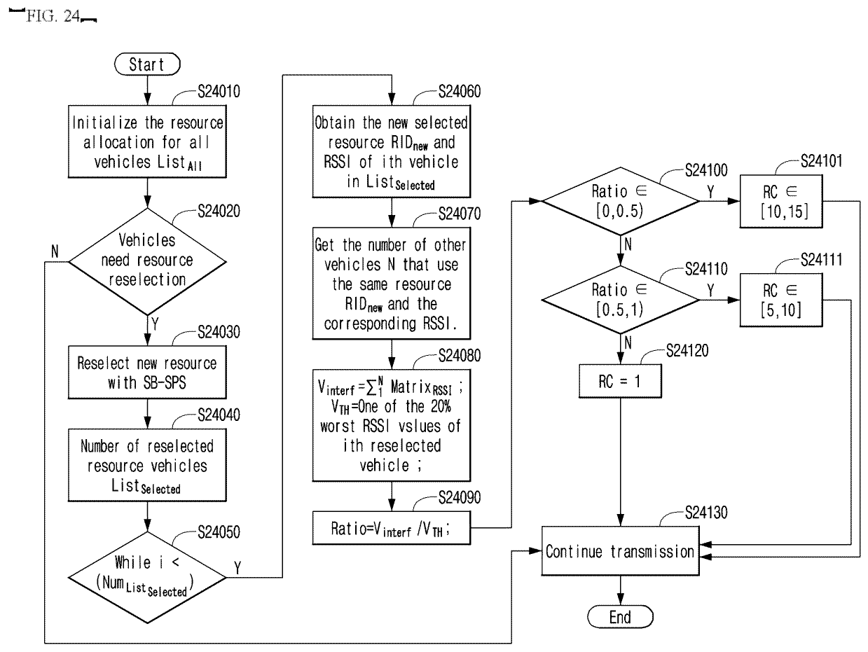

FIG. 22 is a flow diagram illustrating one example of how the resource reselection method proposed in the present disclosure is performed. More specifically, FIG. 22 illustrates an operation in which a PDB is updated among parameters related to resource reselection.

Referring to FIG. 22, a resource allocation list (List all) for all terminals (vehicles) participating in the sidelink communication is initialized (S22010). At this time, the resource allocation list (List all) for all the terminals (vehicles) may include information about the number of all the terminals. The terminal then determines whether resource reselection is required (S22020). If it is determined that resource reselection is not required, the terminal continues to perform the sidelink transmission (S22130). Conversely, if it is determined that resource reselection is required, the device selects a new resource (S22030). At this time, a list of the terminals that have performed the resource reselection may be established (S22040). To establish the list of terminals that have performed the resource reselection, the terminal may receive configuration information from the base station comprising information about the list of terminals that have performed the resource reselection, and the configuration information may be transmitted via upper layer signaling. Thereafter, the terminal obtains an identifier (RID_new) for the (re)selected resource and, based on the list of terminals that have performed the resource reselection, measures RSSI values on the resources that have been reselected by other terminals (S22050, S22060). Next, the terminal obtains the number (N) of other terminals using the same resource (RID_new) as the resource (re)selected by the terminal, and obtains the RSSI value on the resource (RID_new) (S22070). Then, the terminal obtains a V_interf value calculated as a sum of the RSSI matrices corresponding to the other terminals using the same resource as the (re)selected resource (RID_new) measured on the (re)selected resource (RID_new), and a V_TH value set to one of the RSSI values corresponding to the bottom 20% of the RSSI values measured in step S22060 is determined (S22080). Based on the V_interf value and the V_TH value calculated in step S22080, a specific ratio value (Ratio) for updating the resource reselection probability value is calculated (S22090). Generalizing this, it may be understood that the resource reselection parameters associated with resource reselection are reset based on a specific ratio value calculated by dividing (i) the sum of the RSSI (Received Signal Strength Indicator) matrices obtained based on the signals received from the terminals using the same resource as the specific resource reselected by the terminal, respectively, by (ii) the value of one of the matrices corresponding to a lower specific ratio of the total RSSI matrices obtained based on the signals received from all terminals participating in the sidelink communication, respectively. Subsequently, via steps S22100 to S22120, the PDB values (timing values for the start time and timing values for the end time comprising the PDB) are updated/reset. More specifically, if the specific ratio value is greater than 0 and less than 0.5 (S22100), the timing value for the start time point and the timing value for the end time point comprising the PDB may be reset to 1 ms and 100 ms, respectively. After resetting the timing value for the start time and the timing value for the end time comprising the PDB, the terminal may continue the sidelink transmission (S22130). If the specific ratio value is at least 0.5 and less than 1 (S22110), the timing value for the start time and the timing value for the end time comprising the PDB may be reset to 2 ms and 60 ms, respectively. After resetting the timing value for the start time and the timing value for the end time comprising the PDB, the terminal may continue the sidelink transmission (S22130). Finally, if the above specific ratio value is 1, the timing value for the start time point and the timing value for the end time point comprising the PDB may be reset to 4 ms and 20 ms, respectively (S22120). After resetting the timing values for the start time and the timing values for the end time that comprise the PDB, the terminal may continue the sidelink transmission (S22130). Generalizing, it may be understood that the specific ratio value may be a value from among (i) a value within a predefined range that is equal to or greater than zero and less than one, and (ii) a value outside the predefined range, wherein the predefined range includes at least one sub-range. Further, it may be understood that a mapping relationship is predefined between (i) the at least one sub-range and values outside the predefined range and (ii) a timing value for a start time and a timing value for an end time of a time interval associated with the PDB on a time resource.

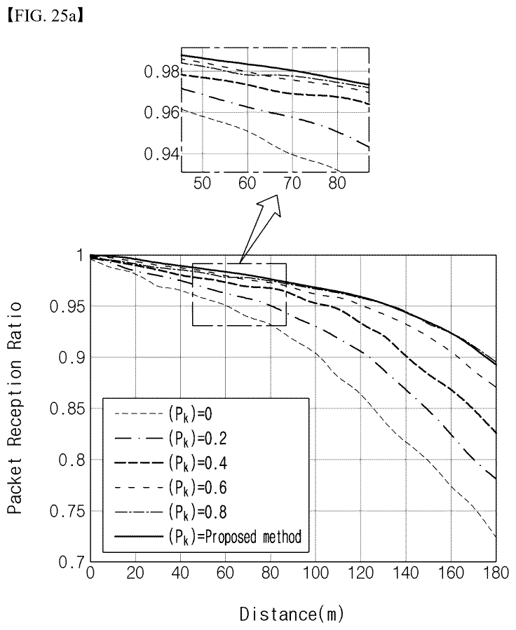

FIG. 23 is a diagram illustrating an example scenario in which a resource reselection method proposed in the present disclosure is performed. FIG. 23 illustrates a case where the parameter associated with resource reselection is a reselection counter. Referring to FIG. 23, it can be seen that the range of candidate values that can be used as the value of the reselection counter and the value of the reselection counter that is reset can vary depending on the degree of resource interference.

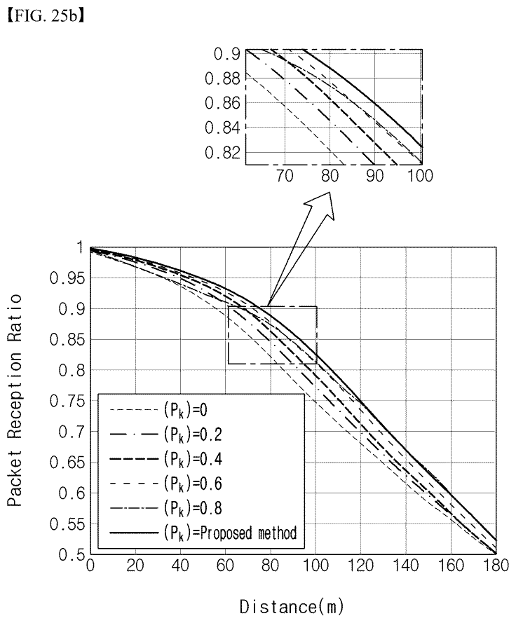

FIG. 24 is a flow diagram illustrating one example of how a resource reselection method proposed in the present disclosure may be performed. More specifically, FIG. 24 illustrates an operation in which, among parameters associated with resource reselection, a resource reselection parameter is updated.

Referring to FIG. 24, a resource allocation list (List all) for all terminals (vehicles) participating in the sidelink communication is initialized (S24010). In this case, the resource allocation list (List all) for all the terminals (vehicles) may include information about the number of all the terminals. The terminal then determines whether resource reselection is required (S24020). If it is determined that resource reselection is not required, the terminal continues to perform the sidelink transmission (S24130). Conversely, if it is determined that resource reselection is required, the device selects a new resource (S24030). At this time, a list of the terminals that have performed the resource reselection may be set (S24040). To establish the list of the terminals that have performed the resource reselection, the terminal may receive configuration information from the base station comprising information about the list of the terminals that have performed the resource reselection, and the configuration information may be transmitted via upper layer signaling. Subsequently, the terminal obtains an identifier (RID_new) for the (re)selected resource and, based on the list of terminals that have performed the resource reselection, measures RSSI values on the resources that have been reselected by other terminals (S24050, S24060). Next, the terminal obtains the number (N) of other terminals using the same resource (RID_new) as the resource (re)selected by the terminal, and obtains the RSSI value on the resource (RID_new) (S24070). Then, the terminal obtains a V_interf value calculated as a sum of the RSSI matrices corresponding to the other terminals using the same resource as the resource (RID_new) as measured on the resource (RID_new) that the terminal (re)selects, and a V_TH value set to one of the RSSI values corresponding to the bottom 20% of the RSSI values measured in step S24060 is determined (S24080). Based on the V_interf value and the V_TH value calculated in step S24080, a specific ratio value (Ratio) for updating the resource reselection probability value is calculated (S24090). Generalizing this, it may be understood that resource reselection parameters associated with the resource reselection are reset based on a specific ratio value, which is calculated by dividing (i) a sum of received signal strength indicator (RSSI) matrices obtained based on signals received respectively from terminals using same resource as the reselected specific resource by (ii) a value of one of matrices corresponding to a lower specific ratio of all RSSI matrices obtained based on signals received respectively from all terminals participating in the sidelink communication. Subsequently, the range of candidate values that may be used as the reselection counter value is updated/reset via steps S24100 to S24120. At this time, the reselection counter value may be randomly determined within the reset candidate value range. When the specific ratio value is greater than 0 and less than or equal to 0.5 (S24100), the range of candidate values that can be used as the reselection counter value may be reset to a range of greater than or equal to 10 and less than or equal to 15. After resetting the range of candidate values that can be used as the reselection counter value, the terminal may continue the sidelink transmission (S24130). If the above specific ratio value is more than 0.5 and less than 1 (S24110), the range of candidate values that can be used as the reselection counter value may be reset to a range of more than 5 and less than 10. After resetting the range of candidate values that can be used as the reselection counter value, the terminal may continue the sidelink transmission (S24130). Finally, if the specific ratio value is 1, the reselection counter value may be set to 1 (S24120). After resetting the range of candidate values that may be used as the reselection counter value, the terminal may continue the sidelink transmission (S24130). Generalizing, it may be understood that the specific ratio value may be a value from among (i) a value within a predefined range that is equal to or greater than zero and less than one, and (ii) a value outside the predefined range, the predefined range comprising at least one sub-range. Further, it may be understood that a mapping relationship between (i) the at least one sub-range and (ii) a range of candidate values for the reselection counter value is predefined, wherein values outside the predefined range are mapped to candidate values for the reselection counter value having a value of 1.

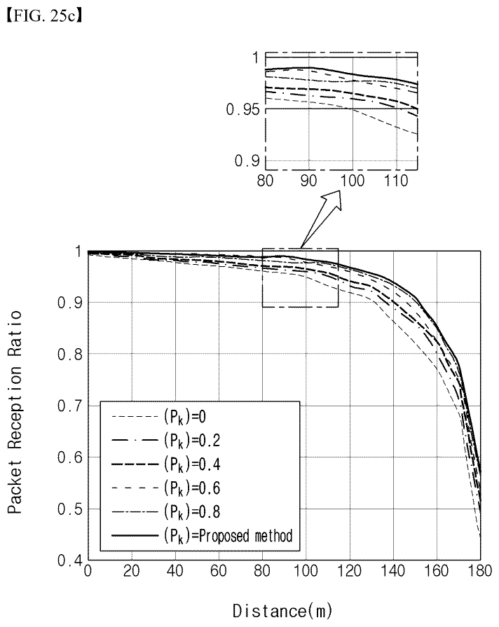

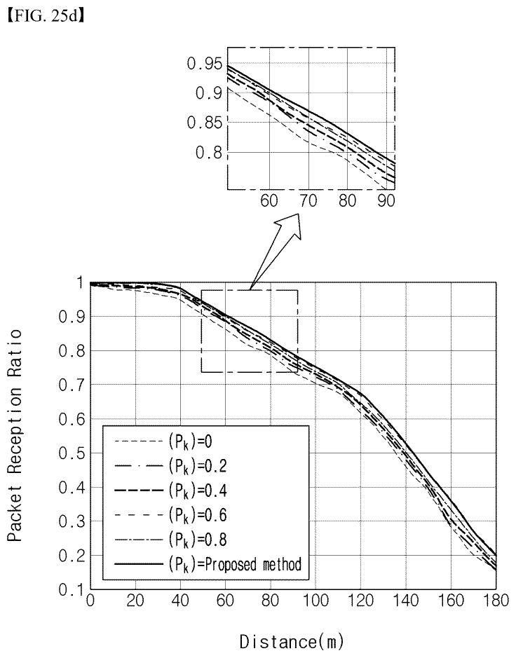

FIGS. 25a through 25d and FIG. 26 illustrate the improved effectiveness of resource reselection behavior using the methods proposed in the present disclosure compared to resource reselection behavior based on a method that uses fixed resource reselection related parameters. More specifically, FIGS. 25 and 26 illustrate the improved effectiveness of the resource reselection behavior with the method proposed herein, where the reselection probability value is reset/updated, compared to the resource reselection behavior based on a fixed reselection probability value (0.2/0.4/0.6/0.8).

First, referring to FIGS. 25A to 25D, it can be seen that the packet reception ratio as a function of distance in the resource reselection scheme proposed in the present disclosure has a higher value compared to the resource reselection scheme based on a fixed reselection probability value (0.2/0.4/0.6/0.8).

Next, referring to FIG. 26, it can be seen that in each of the various scenarios in which sidelink communication may be performed, the packet reception ratio (PRR) range of the resource reselection method based on the fixed reselection probability values (0.2/0.4/0.6/0.8) has a better value compared to the packet reception ratio (PRR) range of the resource reselection method proposed in the present disclosure.

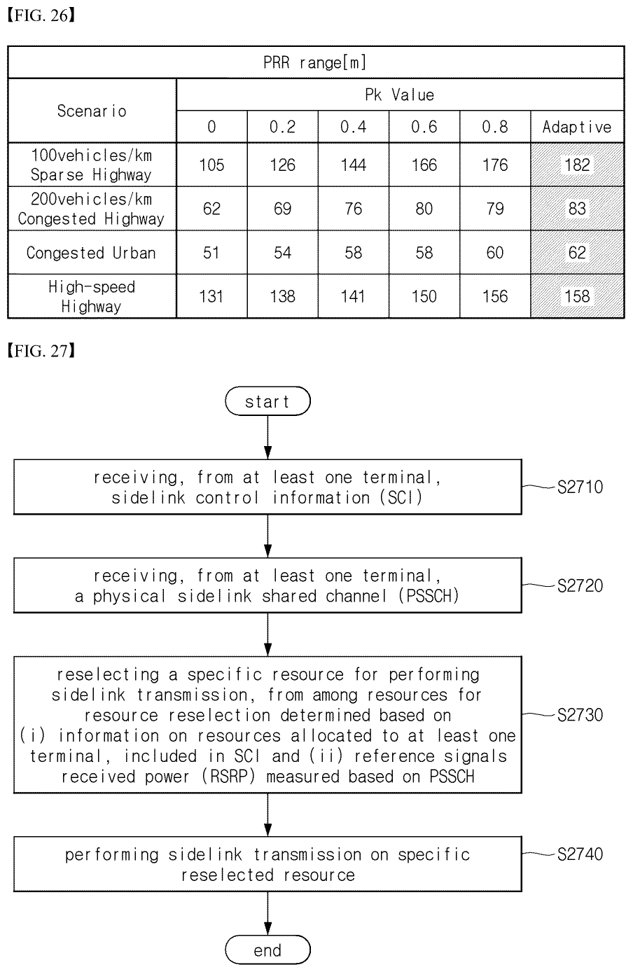

FIG. 27 is a flow diagram illustrating an example of a method for performing a sidelink transmission proposed in the present disclosure at a terminal.

First, the terminal receives sidelink control information (SCI) from the at least one terminal (S2710).

Then, the terminal receives, from the at least one terminal, a physical sidelink shared channel (PSSCH) (S2720).

Next, the terminal reselects a specific resource for performing the sidelink transmission, from among resources for resource reselection determined based on (i) information about resources allocated to the at least one terminal contained in the SCI and (ii) reference signals received power (RSRP) measured based on the PDSSCH (S2730).

Next, the terminal performs the sidelink transmission on the reselected specific resource (S2740).

In this case, resource reselection parameters associated with the resource reselection are reset based on a specific ratio value, which is calculated by dividing (i) a sum of received signal strength indicator (RSSI) matrices obtained based on signals received respectively from terminals using same resource as the reselected specific resource by (ii) a value of one of matrices corresponding to a lower specific ratio of all RSSI matrices obtained based on signals received respectively from all terminals participating in the sidelink communication.

The terminal further comprises one or more transceivers, one or more processors, and one or more memories associated with the one or more processors storing instructions for operations to be executed by the one or more processors, and performing the operations described in FIG. 27.

Further, in an apparatus comprising one or more memories and one or more processors functionally coupled to the one or more memories, the one or more processors control the apparatus to perform the operations described in FIG. 27.

Further, in one or more non-transitory computer-readable media storing one or more instructions, the one or more instructions executable by the one or more processors control the device to perform the actions described in FIG. 27.

Various embodiments of the present disclosure may be combined with each other.

Without limitation, the various descriptions, features, procedures, suggestions, methods, and/or flowcharts of operations disclosed herein may be applied to various fields requiring wireless communication/connectivity (e.g., 5G) between devices.

The operations described herein may be realized by providing any component of the UE or eNB with a memory device storing corresponding program code, i.e., the control unit of the UE or eNB may execute the operations described herein by reading and executing the program code stored in the memory device by a processor or central processing unit (CPU).

The various components, modules, etc. of a UE or eNB described herein may be operated using hardware circuits, such as logic circuits based on complementary metal oxide semiconductors, firmware, software, and/or a combination of hardware and firmware and/or software embedded in a machine-readable medium. For example, various electrical structures and methods may be implemented using electrical circuits such as transistors, logic gates, and custom semiconductors.

While specific embodiments have been described in the detailed description of the present disclosure, various modifications are of course possible without departing from the scope of the disclosure. Therefore, the scope of the present disclosure should not be limited to the described embodiments, but should be defined by the scope of the following patent claims, as well as by things coextensive with the scope of these claims.

1. A method for a terminal to perform a sidelink transmission in a wireless communication system,
receiving, from at least one terminal, sidelink control information (SCI);
receiving, from the at least one terminal, a physical sidelink shared channel (PSSCH);
reselecting a specific resource for performing the sidelink transmission, from among resources for resource reselection determined based on (i) information on resources allocated to the at least one terminal, included in the SCI and (ii) reference signals received power (RSRP) measured based on the PSSCH; and
performing the sidelink transmission on the specific reselected resource,
wherein resource reselection parameters associated with the resource reselection are reset based on a specific ratio value, which is calculated by dividing (i) a sum of received signal strength indicator (RSSI) matrices obtained based on signals received respectively from terminals using same resource as the reselected specific resource by (ii) a value of one of matrices corresponding to a lower specific ratio of all RSSI matrices obtained based on signals received respectively from all terminals participating in the sidelink communication.

2. The method of claim 1,
wherein the resource reselection parameter comprises at least one of (i) a resource reselection probability value, (ii) a packet delay budget (PDB) representing a maximum time that a delay in the side link transmission to be allowed, or (iii) a reselection counter value associated with a determination of whether to perform resource reselection.

3. The method of claim 2,
wherein the specific ratio value is one of (i) a value within a predefined range that is equal to or greater than zero and less than one, and (ii) a value outside the predefined range,

4. The method of claim 3,
wherein the specific ratio value is associated with the resource reselection probability value:
a mapping relationship between the at least one sub-range and the resource reselection probability value having a non-zero value is predefined,
the specific ratio value having a value outside the predefined range is mapped to the resource reselection probability value having a value of zero.

5. The method of claim 3,
wherein the specific ratio value is associated with the PDB:
a mapping relationship is predefined between (i) the at least one sub-range and values outside the predefined range and (ii) a timing value for a start time and a timing value for an end time of a time interval associated with the PDB on a time resource.

6. The method of claim 5,
wherein a PDB time length determined based on the timing value for the start of the time interval associated with the PDB mapped to a value outside the predefined range and the timing value for the end is shorter than a PDB time length determined based on the timing value for the start of the time interval associated with the PDB mapped to the at least one sub-range and the timing value for the end.

7. The method of claim 3,
wherein the specific ration value is associated with the reselection counter value:
a mapping relaxation between the at least one sub-range and candidate value of the reselection counter value is pre-defined,
the value outside the predefined range is mapped to the candidate value having 1 of the reselection counter value.

8. The method of claim 2, further comprising:
determining whether the reselected specific resource is a resource satisfying the reset PDB.

9. The method of claim 8,
wherein in case that the reselected specific resource is the resource satisfying the PDB, further comprising: determining whether the reset reselection counter value is 0,
in case that the reset reselection counter value is not 0, the reset reselection counter value is decremented by 1, and the sidelink transmission is performed,
in case that the reset reselection counter value is 0, the reset reselection counter value is decremented by 1, and the sidelink transmission is performed, another resource reselection is performed, and the another resource reselection is performed based on the reset resource reselection probability value.

10. The method of claim 8,
wherein in case that the reselected specific resource is a resource that does not satisfy the PDB, another resource reselection is performed, and the another resource reselection is performed based on the reset resource reselection probability value.

11. A terminal for performing a sidelink transmission in a wireless communication system, the terminal comprising:
one or more transmitters and receivers;
one or more processors; and
one or more memories associated with the one or more processors, storing instructions for operations executed by the one or more processors,
wherein the operations comprise,
receiving, from at least one terminal, sidelink control information (SCI);
receiving, from the at least one terminal, a physical sidelink shared channel (PSSCH);
reselecting a specific resource for performing the sidelink transmission, from among resources for resource reselection determined based on (i) information on resources allocated to the at least one terminal, included in the SCI and (ii) reference signals received power (RSRP) measured based on the PSSCH; and
performing the sidelink transmission on the specific reselected resource,
wherein resource reselection parameters associated with the resource reselection are reset based on a specific ratio value, which is calculated by dividing (i) a sum of received signal strength indicator (RSSI) matrices obtained based on signals received respectively from terminals using same resource as the reselected specific resource by (ii) a value of one of matrices corresponding to a lower specific ratio of all RSSI matrices obtained based on signals received respectively from all terminals participating in the sidelink communication.

12. An apparatus comprising one or more memories and one or more processors functionally coupled to the one or more memories,
wherein the one or more processors controls the apparatus to:
receive, from at least one terminal, sidelink control information (SCI);
receive, from the at least one terminal, a physical sidelink shared channel (PSSCH);
reselect a specific resource for performing the sidelink transmission, from among resources for resource reselection determined based on (i) information on resources allocated to the at least one terminal, included in the SCI and (ii) reference signals received power (RSRP) measured based on the PSSCH; and
perform the sidelink transmission on the specific reselected resource,
wherein resource reselection parameters associated with the resource reselection are reset based on a specific ratio value, which is calculated by dividing (i) a sum of received signal strength indicator (RSSI) matrices obtained based on signals received respectively from terminals using same resource as the reselected specific resource by (ii) a value of one of matrices corresponding to a lower specific ratio of all RSSI matrices obtained based on signals received respectively from all terminals participating in the sidelink communication.

13. (canceled)
